(19) United States
(12) Patent Application Publication
(10) Pub. No.: US 2024/0346594 A1
(43) Pub. Date: Oct. 17, 2024

(54) SYSTEMS AND METHODS FOR INVESTMENT VEHICLE DISTRIBUTION OF ESCROW FUNDS

(71) Applicant: Seedly, Inc., New York, NY (US)

(72) Inventor: Savannah Grimmett, New York, NY (US)

(73) Assignee: Seedly, Inc., New York, NY (US)

(21) Appl. No.: 18/133,795

(22) Filed: Apr. 12, 2023

(51) Int. Cl. G06Q 40/06; G06Q 20/02; G06Q 20/10

(52) U.S. Cl. CPC G06Q 40/06; G06Q 20/02; G06Q 20/108

(57) ABSTRACT

A system may include an organization creation module, which may receive data from the user and generate a record. The system may include a fund compilation module comprising a fund collection and sufficiency check configured to receive a transfer of funds from one or more users into a deposit account, record the transfer, and compare the funds transferred to a threshold. The system may include an investment selection module configured to provide a selection of investment vehicles and may include risk tolerance information inputs. The system may execute an investment execution module for redirecting the funds into the investment vehicle(s). The system may include an investment tracker module configured to monitor a balance of the deposit account, and display to the user the balance of the deposit account. The system may include an asset distribution module configured to transfer the funds into external accounts in accordance with predetermined parameters.

### FIELD OF THE DISCLOSURE

The present disclosure relates to methods and systems for distribution of funds into investment vehicles. Specifically, the present disclosure relates to compiling funds intended to be held in escrow and distributing those funds into one or more investment products.

### INTRODUCTION

Funds are often held in escrow until they are needed for a particular purpose. For example, funds for Fantasy Sports tournaments are typically collected and held in escrow until the tournament ends, at which point the pooled funds are claimed by the winner of the tournament. Similarly, security deposits for rental properties may typically be held in escrow until the rental period is over, whereby any or all of the deposit may be apportioned to the landlord in the event of any specified circumstances outlined in the lease agreement and any remainder is returned to the tenant.

For reference, there are approximately 40 million Fantasy Football players each year that accumulate about $2 billion in prize money that remains in escrow uninvested throughout the course of the season. Similarly, there are roughly 44 million residential rental properties in the United States with a total of $110 billion in security deposit funds that stay in escrow for the duration of the lease. The aforementioned figure does not include sizing for the commercial rental property market. Though security deposit funds may be placed in interest-bearing bank accounts today, interest-bearing bank accounts are not considered investment vehicles, rather they are generally considered low-risk, low-return savings vehicles.

Thus, it is desirable to have a method and system for compiling funds intended to be held in escrow and distributing those funds into one or more investment products for the duration of the escrow period.

### SUMMARY

Aspects of the present disclosure relate to a computer-implemented system including a processor, a computer-readable memory, a computer-readable storage device, at least one network interface, at least one input interface, at least one output interface, and program instructions stored on the computer-readable storage device for execution by at the processor via the computer-readable memory, the stored program instructions including: receiving, from a user via a client device, instructions to execute an organization creation module, wherein, the organization creation module receives data via an input from the user via the client device, and generates a record of the input on at least one database; receiving, from the user via the client device, instructions to execute a fund compilation module; wherein the fund compilation module includes at least a fund collection step and a fund sufficiency check, wherein the fund collection step includes receiving a transfer of funds from one or more users into a deposit account, and recording the transfer on one or more databases, and wherein the funds sufficiency check includes comparing the funds transferred to a predefined minimum threshold; receiving, from the user via the client device, instructions to execute an investment selection module configured to assess user input via the client device and provide a customized selection of investment vehicles for the funds; wherein the investment selection module includes at least risk tolerance information input by the user via the client device; receiving, from the user via the client device, instructions to execute an investment execution module for redirecting the funds into one or more investment vehicles for a duration of a predefined period; receiving, from the user via the client device, instructions to execute an investment tracker module, wherein the investment tracker module is configured to monitor a balance of the deposit account, and wherein the investment tracker module displays to the user, via a display, the balance of deposit account during the duration of the predefined period; and receiving, from the user via the client device, instructions to execute an asset distribution module, wherein the asset distribution module is configured to transfer the deposit account funds to one or more external accounts in accordance with one or more predetermined parameters.

Aspects of the present disclosure relate to a computer-implemented system, wherein the system collects and compiles funds from all users utilizing a third-party provider to provide an intermediary link between user's bank accounts and the system.

Aspects of the present disclosure relate to a computer-implemented system, wherein the funds are for security deposits for rental properties, and the system collects and compiles funds from all users utilizing a third-party provider to provide an intermediary link between user's bank accounts and the system, and wherein the asset distribution module distributes the funds to the one or more users less one or more fees due to a landlord.

Aspects of the present disclosure relate to a method for investment vehicle distribution of escrow funds, the method including the steps of: receiving, from a user via a client device, instructions to execute an organization creation module, wherein, the organization creation module receives data via an input from the user via the client device, and generates a record of the input on at least one database; receiving, from the user via the client device, instructions to execute a fund compilation module; wherein the fund compilation module includes at least a fund collection step and a fund sufficiency check, wherein the fund collection step includes receiving a transfer of funds from one or more users into a deposit account, and recording the transfer on one or more databases, and wherein the funds sufficiency check includes comparing the funds transferred to a predefined minimum threshold; receiving, from the user via the client device, instructions to execute an investment selection module configured to assess user input via the client device and provide a customized selection of investment vehicles for the funds; wherein the investment selection module includes at least risk tolerance information input by the user via the client device; receiving, from the user via the client device, instructions to execute an investment execution module for redirecting the funds into one or more investment vehicles for a duration of a predefined period; receiving, from the user via the client device, instructions to execute an investment tracker module, wherein the investment tracker module is configured to monitor a balance of the deposit account, and wherein the investment tracker module displays to the user, via a display, the balance of deposit account during the duration of the predefined period; and receiving, from the user via the client device, instructions to execute an asset distribution module, wherein the asset distribution module is configured to transfer the deposit account funds to one or more external accounts in accordance with one or more predetermined parameters.

Aspects of the present disclosure relate to a method, wherein the funds are collected and compiled from all users utilizing a third-party provider to provide an intermediary link between user's bank accounts and the deposit account.

Aspects of the present disclosure relate to a method, wherein the funds are for security deposits for rental properties, and the funds are collected and compiled from all users utilizing a third-party provider to provide an intermediary link between user's bank accounts and the deposit account, and wherein the asset distribution module distributes the funds to the one or more users less one or more fees due to a landlord.

Aspects of the present disclosure relate to a computer-readable storage medium having data stored therein representing software executable by a computer, the software having instructions to: receive, from a user via a client device, instructions to execute an organization creation module, wherein, the organization creation module receives data via an input from the user via the client device, and generates a record of the input on at least one database; receive, from the user via the client device, instructions to execute a fund compilation module; wherein the fund compilation module includes at least a fund collection step and a fund sufficiency check, wherein the fund collection step includes receiving a transfer of funds from one or more users into a deposit account, and recording the transfer on one or more databases, and wherein the funds sufficiency check includes comparing the funds transferred to a predefined minimum threshold; receive, from the user via the client device, instructions to execute an investment selection module configured to assess user input via the client device and provide a customized selection of investment vehicles for the funds; wherein the investment selection module includes at least risk tolerance information input by the user via the client device; receive, from the user via the client device, instructions to execute an investment execution module for redirecting the funds into one or more investment vehicles for a duration of a predefined period; receive, from the user via the client device, instructions to execute an investment tracker module, wherein the investment tracker module is configured to monitor a balance of the deposit account, and wherein the investment tracker module displays to the user, via a display, the balance of deposit account during the duration of the predefined period; and receive, from the user via the client device, instructions to execute an asset distribution module, wherein the asset distribution module is configured to transfer the deposit account funds to one or more external accounts in accordance with one or more predetermined parameters.

Additional aspects related to this disclosure are set forth, in part, in the description which follows, and, in part, will be obvious from the description, or may be learned by practice of this disclosure.

It is to be understood that both the forgoing and the following descriptions are exemplary and explanatory only and are not intended to limit the claimed disclosure or application thereof in any manner whatsoever.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 illustrates a block diagram of a distributed computer system that can implement one or more aspects of the present disclosure.

FIG. 2 illustrates a block diagram of an electronic device that can implement one or more aspects of the present disclosure.

FIG. 3 illustrates a high-level process flow for collecting and investing funds according to aspects of the present disclosure.

FIG. 4 shows an account creation workflow according to an aspect of the present disclosure.

FIG. 5 shows an account creation workflow according to another aspect of the present disclosure.

FIG. 6 shows an organization creation and participant invitation workflow according to an aspect of the present disclosure.

FIG. 7 shows a security deposit management workflow according to an aspect of the present disclosure.

FIG. 8 illustrates a fund compilation module according to an aspect of the present disclosure.

FIG. 9 illustrates a fund compilation module according to another aspect of the present disclosure.

FIG. 10 illustrates an investment recommendation and investment tracker module according to an aspect of the present disclosure.

FIG. 11 illustrates an investment recommendation and investment tracker module according to another aspect of the present disclosure.

FIG. 12 illustrates a post-escrow fund/asset distribution module according to an aspect of the present disclosure.

FIG. 13 illustrates a post-escrow fund/asset distribution module according to another aspect of the present disclosure.

FIG. 14 illustrates pseudo-code for an investment recommendation algorithm according to aspects of the present disclosure.

FIG. 15 shows a high-level system architecture according to aspects of the present disclosure.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

The term “investment vehicles” shall be used herein to describe various structures or methods that individuals or entities use to invest their money across different asset classes, such as stocks, bonds, and real estate. These structures may vary significantly, and may include investment products such as omnibus accounts, mutual funds, exchange-traded funds (ETFs), hedge funds, and private equity funds.

The term “escrow” shall be used herein to describe money that is held by a neutral third party on behalf of two or more parties involved in a transaction or agreement.

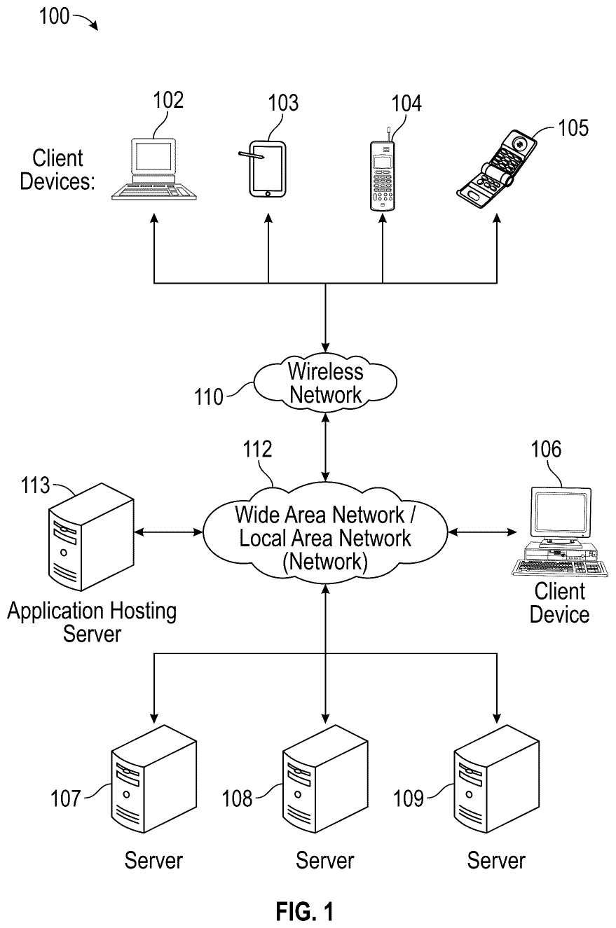

FIG. 1 illustrates components of one embodiment of an environment in which aspects of the present disclosure may be practiced. Not all of the components may be required to practice the invention, and variations in the arrangement and type of the components may be made without departing from the spirit or scope of the invention. As shown, the system 100 includes one or more Local Area Networks (“LANs”)/Wide Area Networks (“WANs”) 112, one or more wireless networks 110, one or more wired or wireless client devices 106, mobile or other wireless client devices 102-105, servers 107-109, and may include or communicate with one or more data stores or databases. Various of the client devices 102-106 may include, for example, desktop computers, laptop computers, set top boxes, tablets, cell phones, smart phones, smart speakers, wearable devices (such as the Apple Watch) and the like. Servers 107-109 can include, for example, one or more application servers, content servers, search servers, and the like. FIG. 1 also illustrates application hosting server 113.

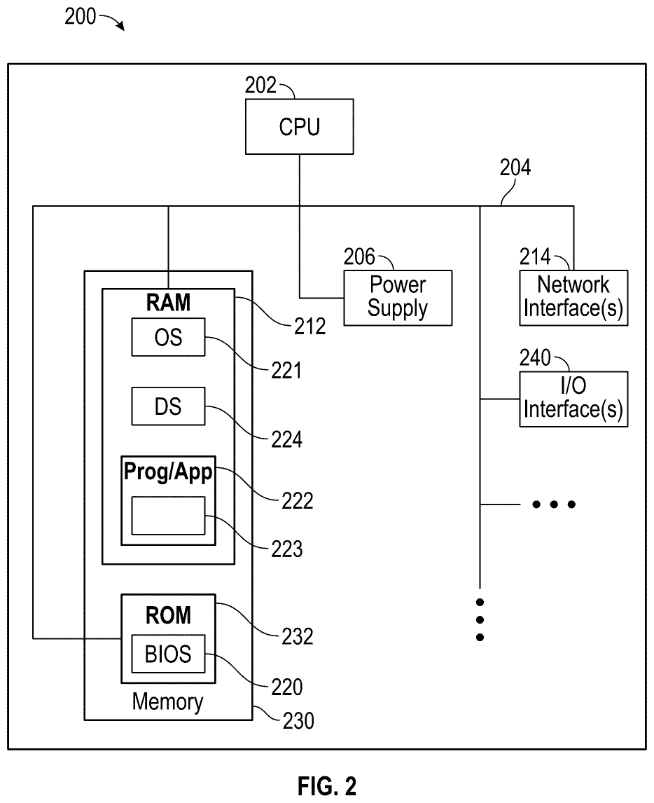

FIG. 2 illustrates a block diagram of an electronic device 200 that can implement one or more aspects of an apparatus, system and/or method for of the present disclosure (the “Engine”). Instances of the electronic device 200 may include servers, e.g., servers 107-109, and client devices, e.g., client devices 102-106. In general, the electronic device 200 can include a processor/CPU 202, memory 230, a power supply 206, and input/output (I/O) components/devices 240, e.g., microphones, speakers, displays, touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen of an electronic device 200. A touchscreen may determine whether a user is providing input by, for example, determining whether the user is touching the touchscreen with a part of the user's body such as his or her fingers. The electronic device 200 can also include a communications bus 204 that connects the aforementioned elements of the electronic device 200. Network interfaces 214 can include a receiver and a transmitter (or transceiver), and one or more antennas for wireless communications.

The processor 202 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be fully embodied as software.

The memory 230, which can include Random Access Memory (RAM) 212 and Read Only Memory (ROM) 232, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating system 221, data storage 224, which may include one or more databases, and programs and/or applications 222, which can include, for example, software aspects of the program 223. The ROM 232 can also include Basic Input/Output System (BIOS) 220 of the electronic device.

Software aspects of the program 223 are intended to broadly include or represent all programming, applications, algorithms, models, software and other tools necessary to implement or facilitate methods and systems according to embodiments of the invention. The elements may exist on a single computer or be distributed among multiple computers, servers, devices or entities.

The power supply 206 contains one or more power components and facilitates supply and management of power to the electronic device 200.

The input/output components, including Input/Output (I/O) interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can ease processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the Engine, via a network to another device. Also, an application server may, for example, host a web site that can provide a user interface for administration of example aspects of the Engine.

Any computing device capable of sending, receiving, and processing data over a wired and/or a wireless network may act as a server, such as in facilitating aspects of implementations of the Engine. Thus, devices acting as a server may include devices such as dedicated rack-mounted servers, desktop computers, laptop computers, set top boxes, integrated devices combining one or more of the preceding devices, and the like.

Servers may vary widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, and the like.

A server may include, for example, a device that is configured, or includes a configuration, to provide data or content via one or more networks to another device, such as in facilitating aspects of an example apparatus, system and method of the Engine. One or more servers may, for example, be used in hosting a Web site, such as the web site www.microsoft.com. One or more servers may host a variety of sites, such as, for example, business sites, informational sites, social networking sites, educational sites, wikis, financial sites, government sites, personal sites, and the like.

Servers may also, for example, provide a variety of services, such as Web services, third-party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of an example systems and methods for the apparatus, system and method embodying the Engine. Content may include, for example, text, images, audio, video, and the like.

In example aspects of the apparatus, system and method embodying the Engine, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, sensor-equipped devices, laptop computers, set top boxes, wearable computers such as the Apple Watch and Fitbit, integrated devices combining one or more of the preceding devices, and the like.

Client devices such as client devices 102-106, as may be used in an example apparatus, system and method embodying the Engine, may range widely in terms of capabilities and features. For example, a cell phone, smart phone or tablet may have a numeric keypad and a few lines of monochrome Liquid-Crystal Display (LCD) display on which only text may be displayed. In another example, a Web-enabled client device may have a physical or virtual keyboard, data storage (such as flash memory or SD cards), accelerometers, gyroscopes, respiration sensors, body movement sensors, proximity sensors, motion sensors, ambient light sensors, moisture sensors, temperature sensors, compass, barometer, fingerprint sensor, face identification sensor using the camera, pulse sensors, heart rate variability (HRV) sensors, beats per minute (BPM) heart rate sensors, microphones (sound sensors), speakers, GPS or other location-aware capability, and a 2D or 3D touch-sensitive color screen on which both text and graphics may be displayed. In some embodiments multiple client devices may be used to collect a combination of data. For example, a smart phone may be used to collect movement data via an accelerometer and/or gyroscope and a smart watch (such as the Apple Watch) may be used to collect heart rate data. The multiple client devices (such as a smart phone and a smart watch) may be communicatively coupled.

Client devices, such as client devices 102-106, for example, as may be used in an example apparatus, system and method implementing the Engine, may run a variety of operating systems, including personal computer operating systems such as Windows, iOS or Linux, and mobile operating systems such as iOS, Android, Windows Mobile, and the like. Client devices may be used to run one or more applications that are configured to send or receive data from another computing device. Client applications may provide and receive textual content, multimedia information, and the like. Client applications may perform actions such as browsing webpages, using a web search engine, interacting with various apps stored on a smart phone, sending and receiving messages via email, SMS, or MMS, playing games (such as fantasy sports leagues), receiving advertising, watching locally stored or streamed video, or participating in social networks.

In example aspects of the apparatus, system and method implementing the Engine, one or more networks, such as networks 110 or 112, for example, may couple servers and client devices with other computing devices, including through wireless network to client devices. A network may be enabled to employ any form of computer readable media for communicating information from one electronic device to another. The computer readable media may be non-transitory. A network may include the Internet in addition to Local Area Networks (LANs), Wide Area Networks (WANs), direct connections, such as through a Universal Serial Bus (USB) port, other forms of computer-readable media (computer-readable memories), or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 110, as in an example apparatus, system and method implementing the Engine, may couple devices with a network. A wireless network may employ stand-alone ad-hoc networks, mesh networks, Wireless LAN (WLAN) networks, cellular networks, and the like.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, Long Term Evolution (LTE) radio access for cellular systems, WLAN, Wireless Router (WR) mesh, and the like. Access technologies such as 2G, 2.5G, 3G, 4G, and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPV6. The Internet includes local area networks (LANs), Wide Area Networks (WANs), wireless networks, and long-haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in an example apparatus, system and method implementing the Engine, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Embodiments of the present invention include apparatuses, systems, and methods implementing the Engine. Embodiments of the present invention may be implemented on one or more of client devices 102-106, which are communicatively coupled to servers including servers 107-109. Moreover, client devices 102-106 may be communicatively (wirelessly or wired) coupled to one another. In particular, software aspects of the Engine may be implemented in the program 223. The program 223 may be implemented on one or more client devices 102-106, one or more servers 107-109, and 113, or a combination of one or more client devices 102-106, and one or more servers 107-109 and 113.

In an embodiment, the system may receive, process, generate and/or store time series data. The system may include an application programming interface (API). The API may include an API subsystem. The API subsystem may allow a data source to access data. The API subsystem may allow a third-party data source to send the data. In one example, the third-party data source may send JavaScript Object Notation (“JSON”)-encoded object data. In an embodiment, the object data may be encoded as XML-encoded object data, query parameter encoded object data, or byte-encoded object data.

The present disclosure may relate to a computer-implemented system for redirecting funds into one or more investment vehicles for a predefined period and methods thereof. The platform may be effective for users engaged in a fantasy sports tournament or for security deposits for rental properties. The platform may also be useful in several other scenarios, including real estate transactions, business acquisitions, or other scenarios in which funds may be held in escrow.

The platform may provide a method for compiling escrow funds and utilizing an algorithm to offer a tailored selection of investment vehicles best suited to maximize the return on investment for the duration of the escrow period.

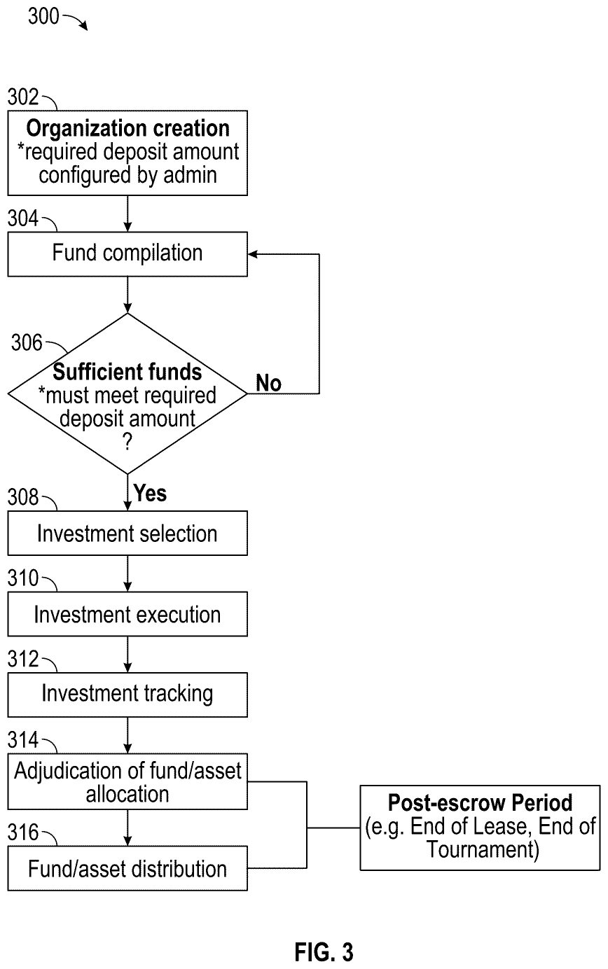

FIG. 3 illustrates a high-level process flow for collecting and investing funds according to aspects of the present disclosure. Specifically, FIG. 3 is an illustrative block diagram of process 300 for collecting and investing funds. Such funds may include funds intended to be held in escrow. Process 300 may consist of various program modules including programs, objects, components, data structures, and so on that may perform particular tasks or implement particular abstract data types. Process 300 may include all modules discussed herein. In a distributed computing environment, these modules may be located in both local and remote storage devices including memory storage devices. Each module may be executed as a result of execution instructions received via client device 102-106.

Administrative users may initiate use of process 300 via one or more client devices 102-105. The first step of process 300 may include organization creation 302. Organization creation 302 may comprise organization naming and configuration of a required deposit amount. Organization naming may allow an administrative user to name, via client device 102-105, a rental property or a tournament league and designate participants, including tenants or league players. For example, an administrative user may name the organization “Football League” for a fantasy sports league, or “123 Smith Lane” for a rental property.

Organization creation 302 may require the administrative user to configure, via client device 102-106, a required deposit type and/or amount. In an embodiment, the required deposit amount may include the security deposit amount for a rental property deposit type. In another embodiment, the required deposit amount may include the total pooled prize money for a tournament deposit type. The required deposit amount may be in the format of a currency and/or crypto currency, such as U.S. Dollars, Great British Pounds, Bitcoin, or any other suitable currency and/or crypto currency.

Organization creation 302 may further comprise creation of a deposit account, in which funds may later be pooled (discussed in further detail below). Organization creation 302 may include a step in which administrative user(s) indicate(s) their risk tolerance and the length of escrow period 318 via client device 102-106. In an embodiment, the length of escrow period 318 may mirror the length of a lease for a rental property, the length of the tournament/league, or any other suitable length of time.

The process 300 may include fund compilation 304. Fund compilation 304 may comprise a step in which participants, via client device(s) 102-106, connect their payment accounts, hereinafter referenced as “Participant account connection” 322. Fund compilation 304 may comprise a funds transfer 324 in which participants use client device(s) 102-106 to move a predetermined sum of money from their own account to the deposit account. In an embodiment, once money is moved into deposit account it joins a pool of funds referred to as escrow funds 326.

Process 300 may include sufficient funds check 306. Sufficient funds check 306 may comprise a feedback loop to verify that the sum of escrow funds 326 in deposit account meets the required deposit amount/minimum threshold. In an embodiment, process 300 is performed via one or more servers 107-109 and 113. In an embodiment, if the balance of escrow funds 326 does not meet the required deposit amount, process 300 will repeat fund compilation 304 until the required deposit amount has been satisfied by the balance of the escrow funds 326. In an embodiment, if the balance of escrow funds 326 meets the required deposit amount, process 300 will continue to the investment selection phase 308.

Investment selection phase 308 may include an interface by which administrative user(s) may utilize client device(s) 102-106 to select a desired investment vehicle 342 for the escrow funds 326. Investment selection phase 308 may present several investment vehicles to administrative user(s), from which administrative user(s) may select the desired investment vehicle 342 based on their specific circumstances. As a non-limiting example, an administrative user that indicates a five-year length of escrow period 318 may be presented with a variety of investment vehicles which offer higher potential long-term returns, but may be subject to fluctuations in the short term. As an alternative non-limiting example, an administrative user that indicates a 3-month length of escrow period 318 may be presented with a variety of investment vehicles which are more volatile, such as stocks or mutual funds. In an embodiment, the variety of investment vehicle options presented to the administrative user is adjusted based on the risk tolerance indicated earlier in process 300.

After the investment selection phase 308, process 300 may continue to the investment execution phase 310. The investment execution phase 310 may be executed by servers 107-109 and 113. The investment execution phase 310 may comprise a transfer to investment vehicle, in which escrow funds 326 are moved from deposit account to the desired investment vehicle 342. Once escrow funds 326 are invested into the desired investment vehicle 342, they may be considered invested funds 354.

Following the investment execution phase 310, process 300 may continue to the investment tracking phase 312. The investment tracking phase 312 may be executed by one or more of servers 107-109 and 113. The investment tracking phase 312 may have a duration equal to the length of escrow period 318. The investment tracking phase 312 may include a module which allows both administrative user(s) and participant(s) visibility into the balance of the invested funds 354. At the close of the investment tracking phase 312, the invested funds 354 may be returned to the deposit account for distribution to administrative user(s) and participant(s). Once invested funds 354 are returned to the deposit account for distribution, they may be termed funds to be distributed 362.

Upon completion of the investment tracking phase 312, process 300 may continue to the asset allocation phase 314. The asset allocation phase 314 may comprise a determination by the administrative user(s) of which parties are entitled to what portion of the balance of the invested funds 354. Administrative user(s) may indicate their desired asset allocation preferences via client device(s) 102-106. In an embodiment, a tenant who has satisfied their lease requirements may be entitled to return of the entire balance of funds to be distributed 362. In an alternative embodiment, a first place winner of a tournament may take 50% of the funds to be distributed 362, a second place winner of a tournament may take 30% of the funds to be distributed 362, and a third place winner of a tournament may take 20% of the funds to be distributed 362.

Process 300 may conclude with the post-escrow period 380. The post-escrow period 380 may comprise the withdrawal process 382, in which the funds to be distributed 362 may be transferred to personal financial accounts. The withdrawal process 382 may comprise liquidation of assets and transfer of dollars to a personal bank account, or in an alternative embodiment the withdrawal process 382 may comprise allowing assets to remain invested and transferring the investment to a personal brokerage account. The withdrawal process 382 may be implemented on one or more of servers 107-109 and 113.

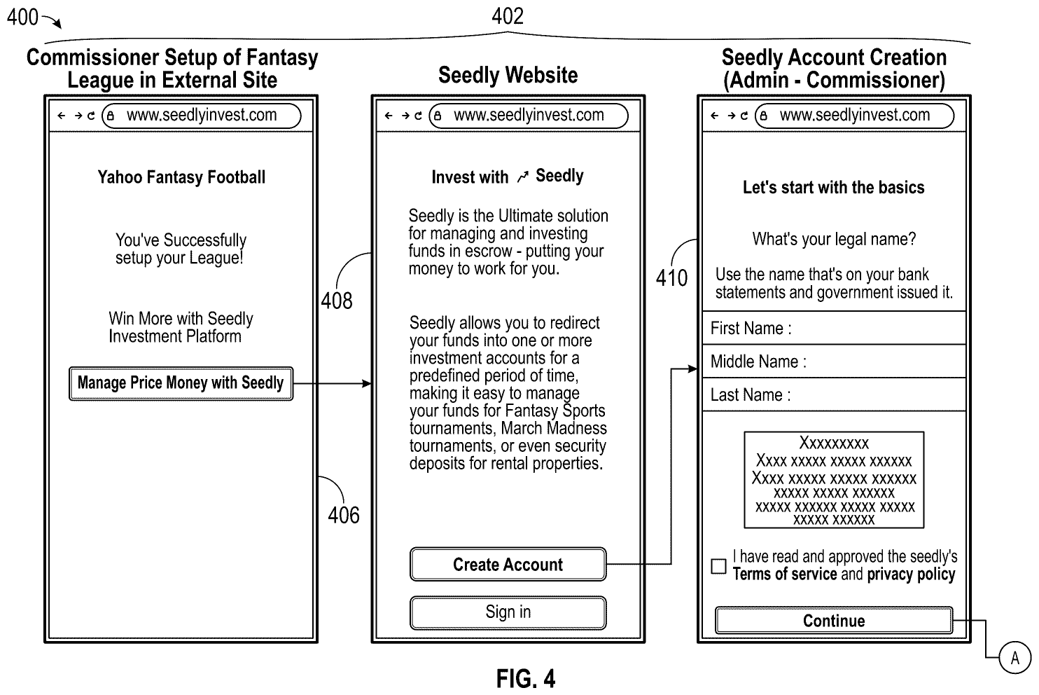

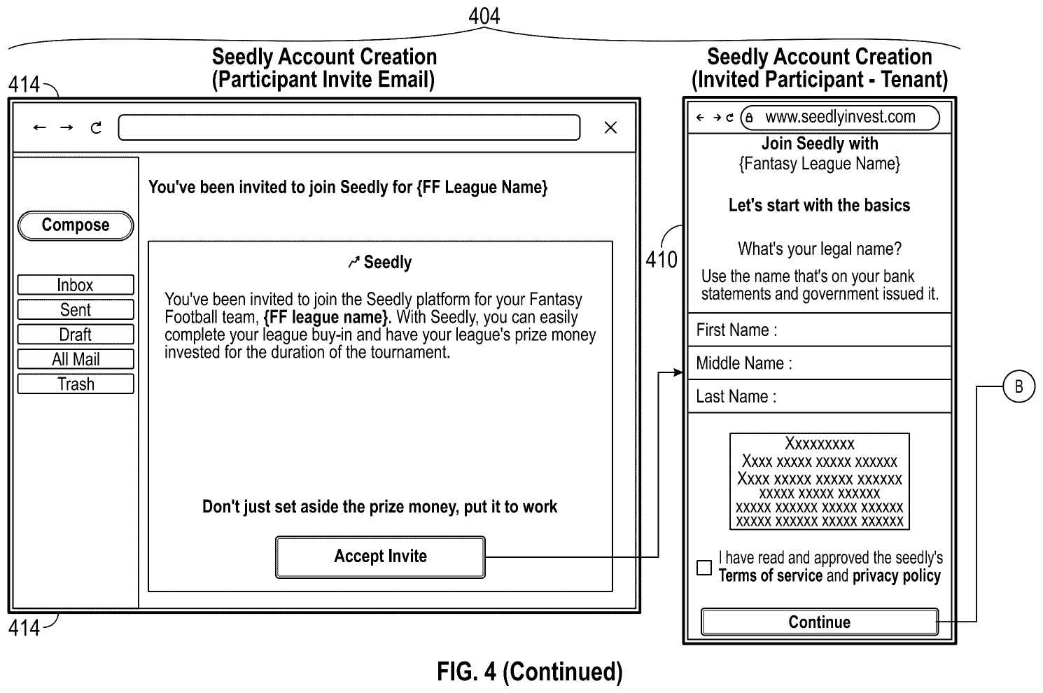

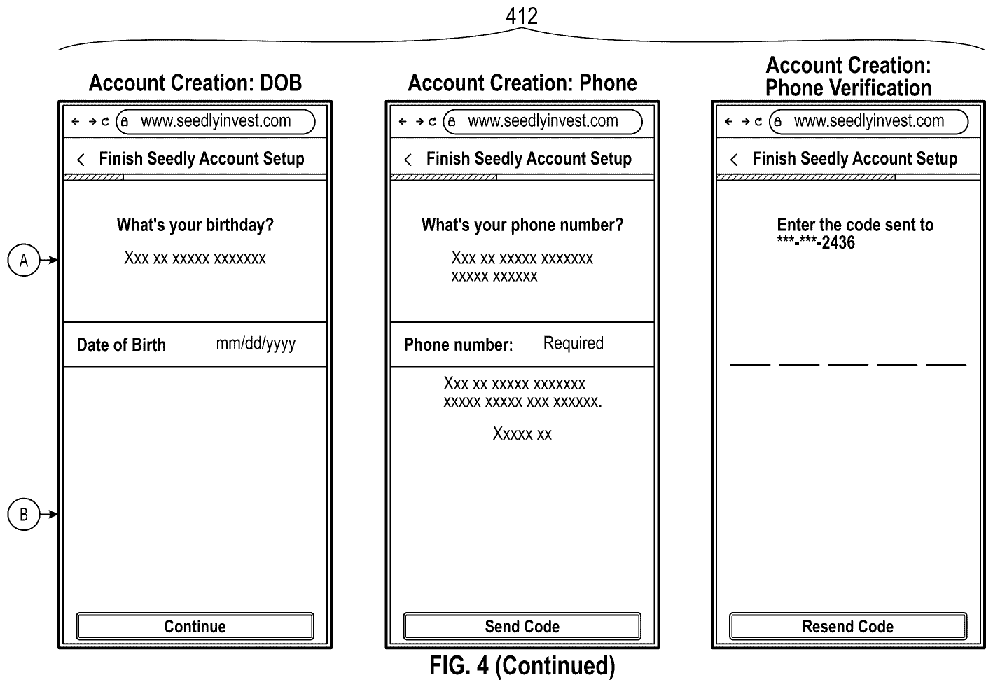

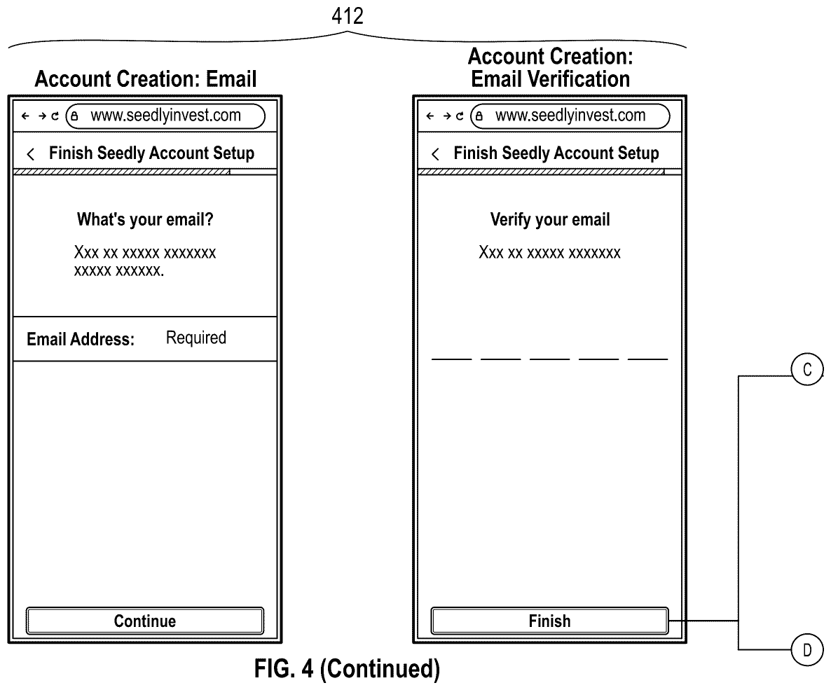

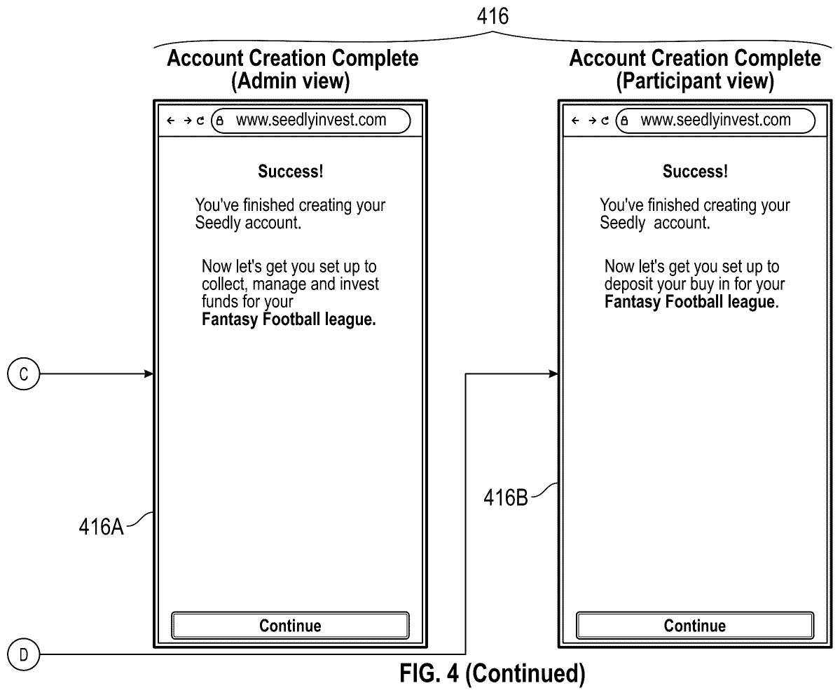

FIG. 4 shows an account creation 400 workflow according to an aspect of the present disclosure. In such an embodiment, the account creation 400 may be tailored to the intended use of the platform. For example, account creation 400 may be applicable to fantasy league/tournament use cases.

Account creation 400 may include an administrative user setup 402 and a participant user setup 404. Administrative user setup 402 may include the setup of a fantasy league or tournament by an administrative user. Such setup 402 may take place on an external website 406. However, in another embodiment, the setup 402 may take place on the platform. In an embodiment, administrative user setup 402 may be implemented via one or more client devices 102-106. In an embodiment, participant user setup 404 may be implemented via one or more client devices 102-106.

After creating a fantasy league or tournament, the administrative user may be redirected to the platform landing page 408. The external website 406 may communicate certain information about the fantasy league or tournament to the platform, such as name, number of participants, type of sport, or any of suitable type of information. In an embodiment, the external website 406 communicates information specific to the administrative user to the platform for purposes of account creation. Such information may include the name, contact information, email, address, or any other suitable information concerning the administrative user. The platform landing page 408 may be displayed to user(s) via one or more client devices 102-106.

From the platform landing page 408, the administrative user may be displayed an option to sign in, or create an account. The administrative user may then sign in to bypass account creation 400, or may select the option to create an account.

If the administrative user selects an option to create an account, the administrative user may be displayed account creation screen 410. The account creation screen 410 may include prompts 412. Prompts 412 may include a plurality of information about the user. For example, the prompts 412 may include requests for information including the user's date of birth (“DOB”), phone number, and email address. The account creation screen 410 may be displayed by one or more client device(s) 102-106.

When requesting the user's phone number and/or email address, the prompts 412 may initiate a verification process to verify the user-input information. To verify the user's phone number or email address, the platform may send a verification code to the phone number/email provided. The user may then have to enter the code into the prompts 412 to verify the phone number and/or email address. The user may utilize one or more of the I/O interfaces 240 affiliated with one or more client devices 102-106 to enter the code into the prompts 412.

A standard user/participant may be directed to the account creation screen 410 via an invitation screen 414. The invitation screen 414 may be displayed to the user through an email or webpage. In an embodiment, the email containing the invitation screen 414 may be sent to the user from the administrative user. In another embodiment, the invitation screen 414 may be sent to the user automatically upon the administrative user entering the user's information into the platform.

The standard user/participant may then be directed to account creation screen 410 and subsequent prompts 412 as described above.

After the prompts 412 have been completed the user may be displayed with an account creation complete screen 416. The account creation complete screen 416 may display different information to the user depending on whether the user is a standard user/participant, or an administrative user. The account creation complete screen 416 may be presented to user via one or more client devices 102-106.

If the user is an administrative user, the user may be displayed with account creation complete screen 416A. Account creation complete screen 416A may include information directing the user to proceed to manage and select investment options. Selecting the investment options may include investment selection phase 308. Account creation complete screen 416A may be presented to a user via one or more I/O interface(s) 240 within one or more client devices 102-106.

If the user is a standard user/participant, the user may be displayed with account creation complete screen 416B. Account creation complete screen 416B may include information directing the user to proceed to complete fund compilation 304. Account creation complete screen 416B may be presented to a user via one or more I/O interface(s) 240 within one or more client devices 102-106.

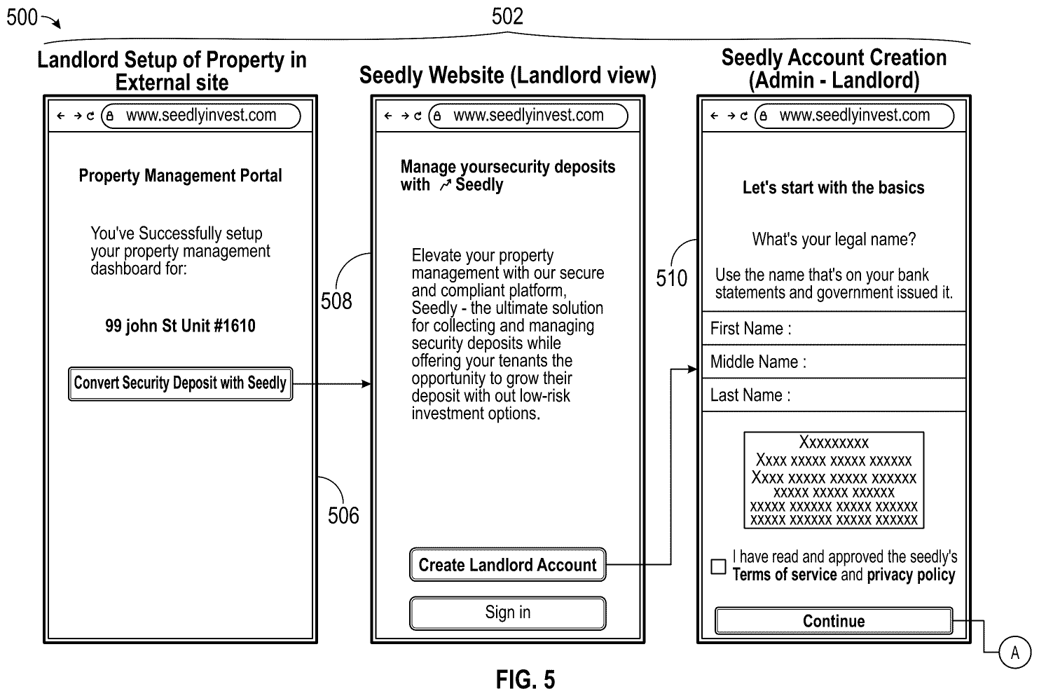

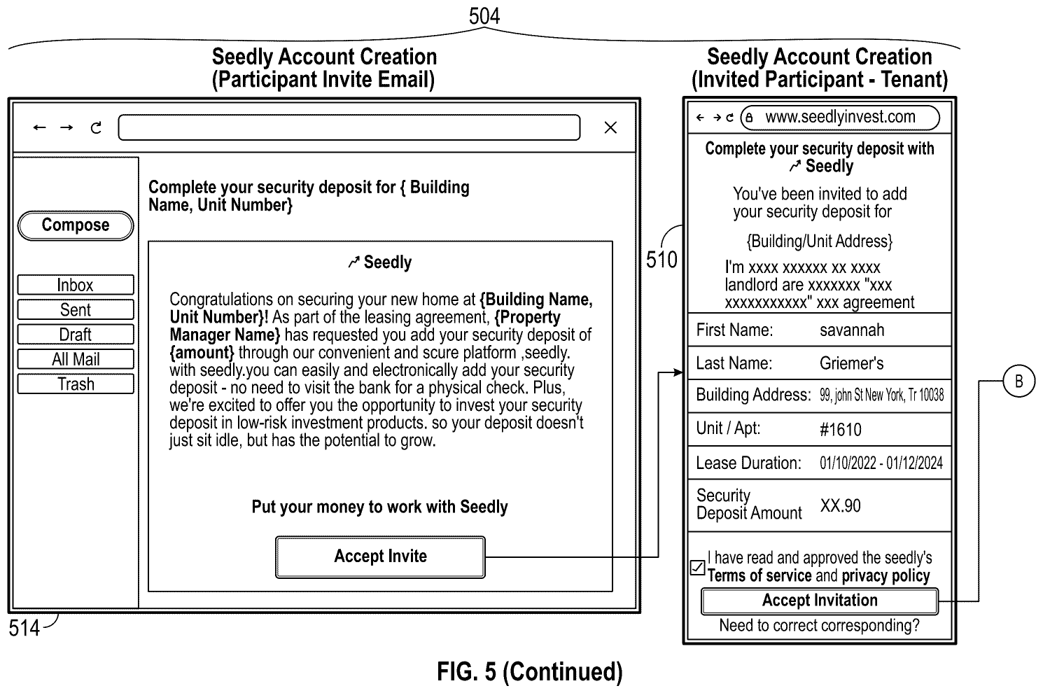

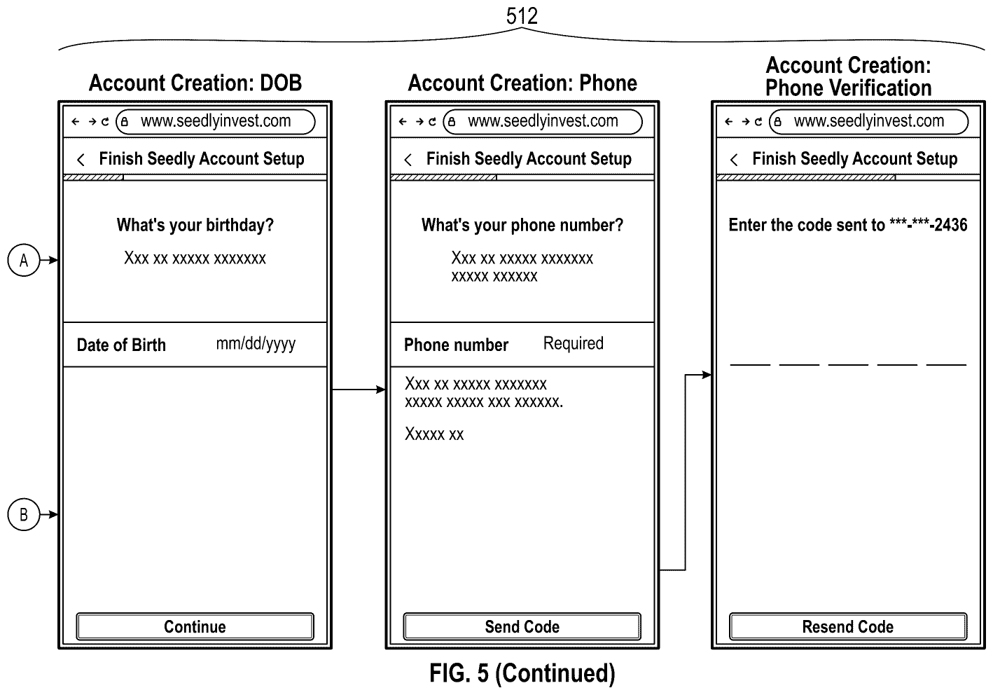

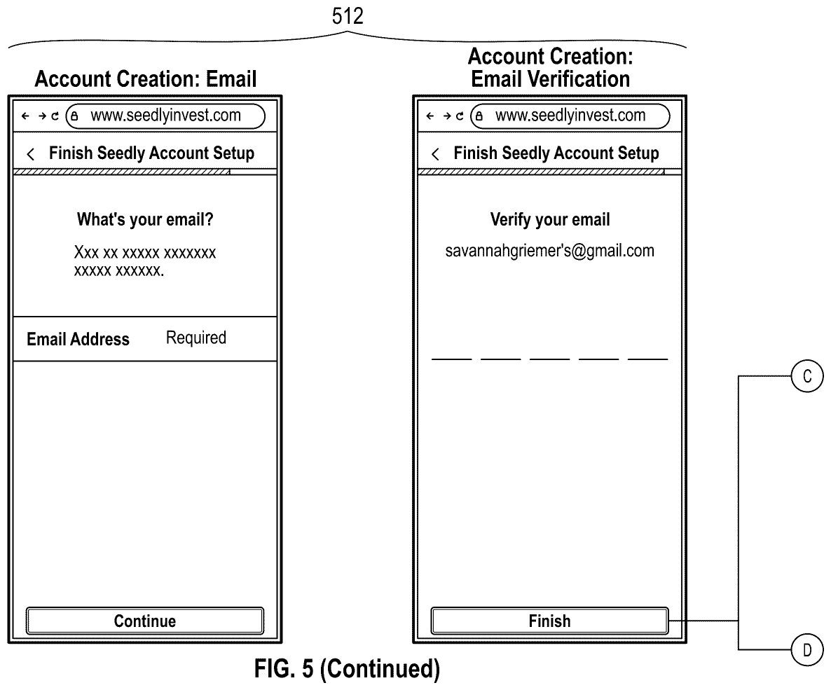

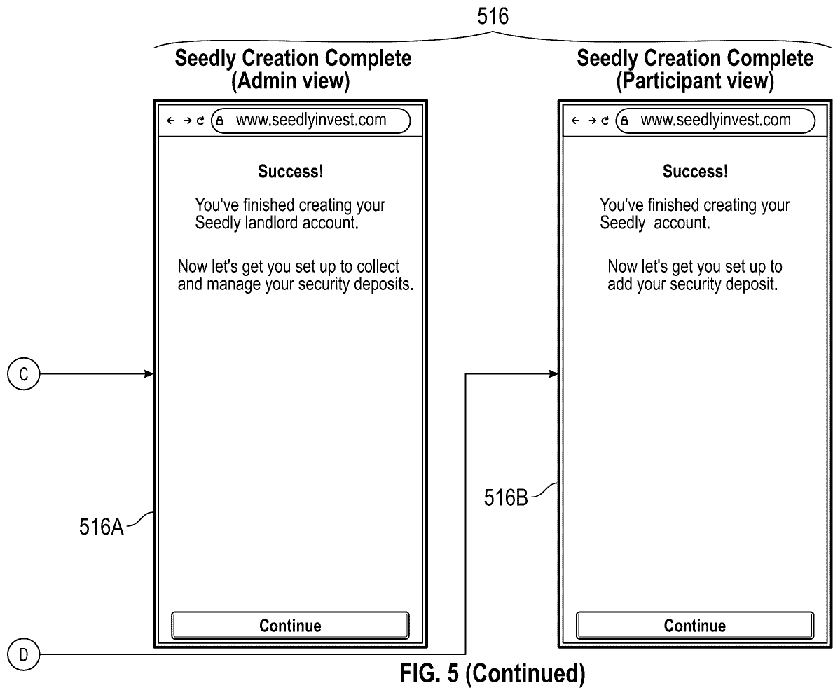

The platform may include account creation 500 as shown in FIG. 5. In an embodiment, account creation 500 is applicable to real estate security deposit use cases.

Account creation 500 may include an administrative user setup 502 and a participant user setup 504. Administrative user setup 502 may include the setup of a property record to which a security deposit will be collected by an administrative user. Such setup 502 may take place on an external website 506. However, in another embodiment, the setup 502 may take place on the platform.

After creating property record to which a security deposit will be collected, the administrative user may be redirected to the platform landing page 508. The external website 506 may communicate certain information about the rental property and/or security deposit amount to the platform, such as address, currency, currency amount, tenant information, or any of suitable type of information. In an embodiment, the external website 506 communicates information specific to the administrative user to the platform for purposes of account creation. Such information may include the name, contact information, email, address, property name, property address, or any other suitable information concerning the administrative user.

From the platform landing page 508, the administrative user may be displayed an option to sign in, or create an account. The administrative user may then sign in to bypass account creation 500, or may select the option to create an account.

If the administrative user selects an option to create an account, the administrative user may be displayed account creation screen 510. The account creation screen 510 may include prompts 512. Prompts 512 may include a plurality of information about the user. For example, the prompts 512 may include requests for information including the user's date of birth (“DOB”), phone number, and email address. Prompts 512 may be presented to user via one or more I/O interface(s) within one or more client device(s) 102-106.

When requesting the user's phone number and/or email address, the prompts 512 may initiate a verification process to verify the user-input information. To verify the user's phone number or email address, the platform may send a verification code to the phone number/email provided. The user may then have to enter the code into the prompts 512 to verify the phone number and/or email address. As a non-limiting example, users may respond to prompts 512 using I/O interfaces such as a keyboard, touchscreen, mouse, or keypad of a client device 102-106.

A standard user/tenant may be directed to the account creation screen 510 via an invitation screen 514. The invitation screen 514 may be displayed to the user through an email or webpage. In an embodiment, the email containing the invitation screen 514 may be sent to the user from the administrative user. In another embodiment, the invitation screen 514 may be sent to the user automatically upon the administrative user entering the user's information into the platform. The invitation screen 514 may be presented to user via one or more I/O interface(s) 240 within one or more client devices 102-106.

The standard user/tenant may then be directed to account creation screen 510 and subsequent prompts 512 as described above.

Prompts 512 may request specialized information specific to the type of user. For example, prompts 512 may request, from an administrative user, information including the deposit amount, the term of the deposit, how much of the deposit is intended to be held as escrow funds 326, or any other relevant information. For a standard user/tenant, prompts 512 may request information including social security number, drivers, license information, or any other relevant information. As a non-limiting example, a standard user/tenant may respond to prompts 512 by relaying relevant information via one or more client device(s) 102-106.

After the prompts 512 have been completed the user may be displayed with an account creation complete screen 516. The account creation complete screen 516 may display different information to the user depending on whether the user is a standard user/tenant, or an administrative user. The account creation complete screen 516 may be presented to administrative user(s) and/or standard user(s)/tenant(s) via one or more I/O interface(s) 240 within one or more client devices 102-106.

If the user is an administrative user, the user may be displayed with account creation complete screen 516A. Account creation complete screen 516A may include information directing the user to proceed to manage and select investment options for the security deposit. Selecting the investment options may include investment selection phase 308. Account creation complete screen 516A may be presented to user via one or more I/O interface(s) 240 within one or more client devices 102-106.

If the user is a standard user/tenant, the user may be displayed with account creation complete screen 516B. Account creation complete screen 516B may include information directing the user to proceed to complete fund compilation 304. Account creation complete screen 516B may be presented to user via one or more I/O interface(s) 240 within one or more client devices 102-106.

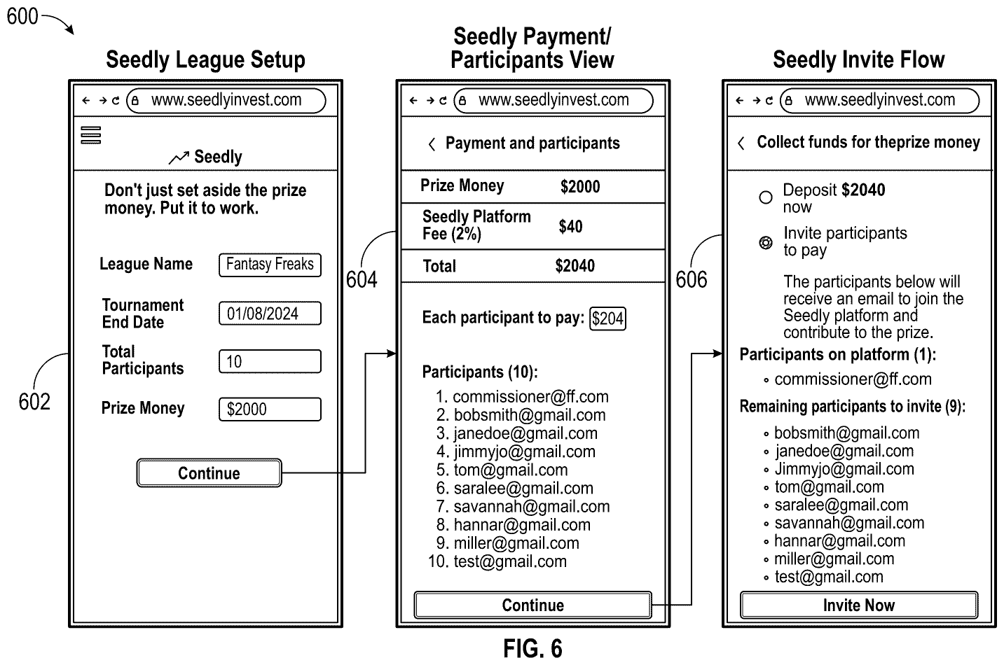

Turning to FIG. 6, as discussed above, administrative user setup 402 may take place on the platform. In such an embodiment, administrative user setup 402 may include organization creation 302. Organization creation 302 may include the steps shown in organization creation 600. Organization creation 600 may include league setup 602. League setup 602 may prompt a user, via a display of the client device 102-106, one or more fields in which the user may enter information relating the league/tournament to be setup. Such information may include information specific to the league/tournament, such as league/tournament name, league/tournament start date, league/tournament end date, number of participants, and/or information regarding the distribution of prize money, particularly the allotted amounts for winner(s) of the league/tournament.

After entering information during league setup 602, the user may interact with a virtual button to cause the client device 102-106 to display a payment/participant view 604. The payment/participant view 604 may provide one or more fields for the user to enter information such as the amount each standard user/participant is to pay. During league setup 602, or when in the payment/participant view 604, the user may enter the email addresses of each standard user/participant.

Next, the user may interact with a virtual button to be directed to invite flow 606. Invite flow 606 may then provide instructions for initiating fund compilation 304. Such instructions may include one or more options, such as an option for the user to pay the total prize money input during league setup 602, or may provide the option to invite each standard user/participant to pay an amount specified in the participant view 604. Such instructions may be presented to user via one or more client devices 102-106. If the user selects the option to invite each standard user/participant to pay an amount specified in the participant view 604, the selection may cause each standard user/participant to be sent invitation screen 414.

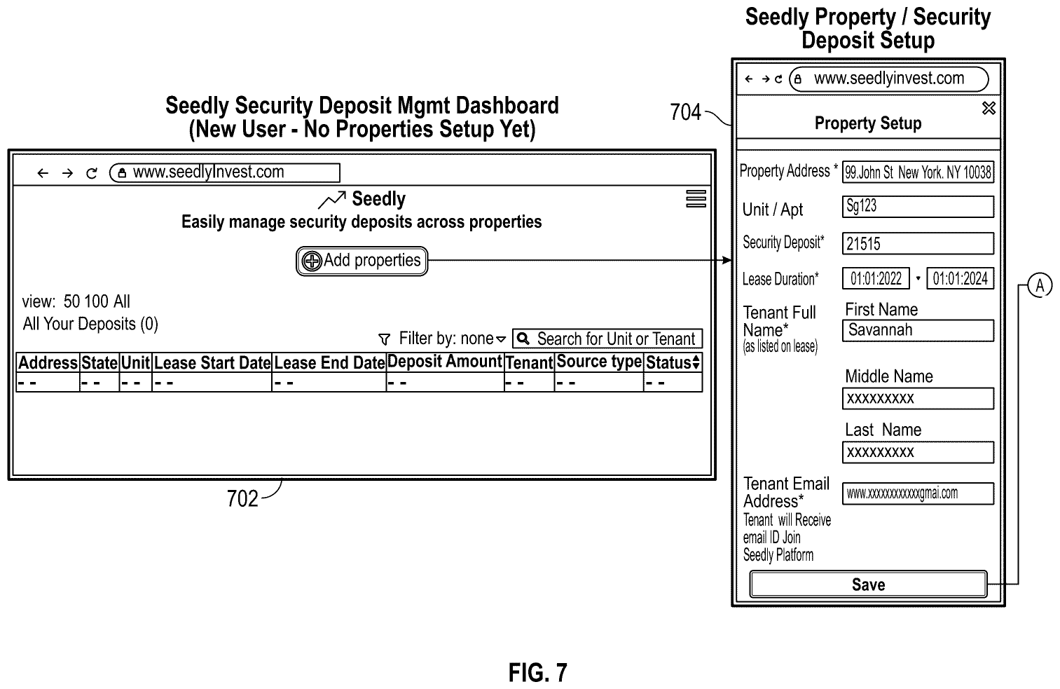

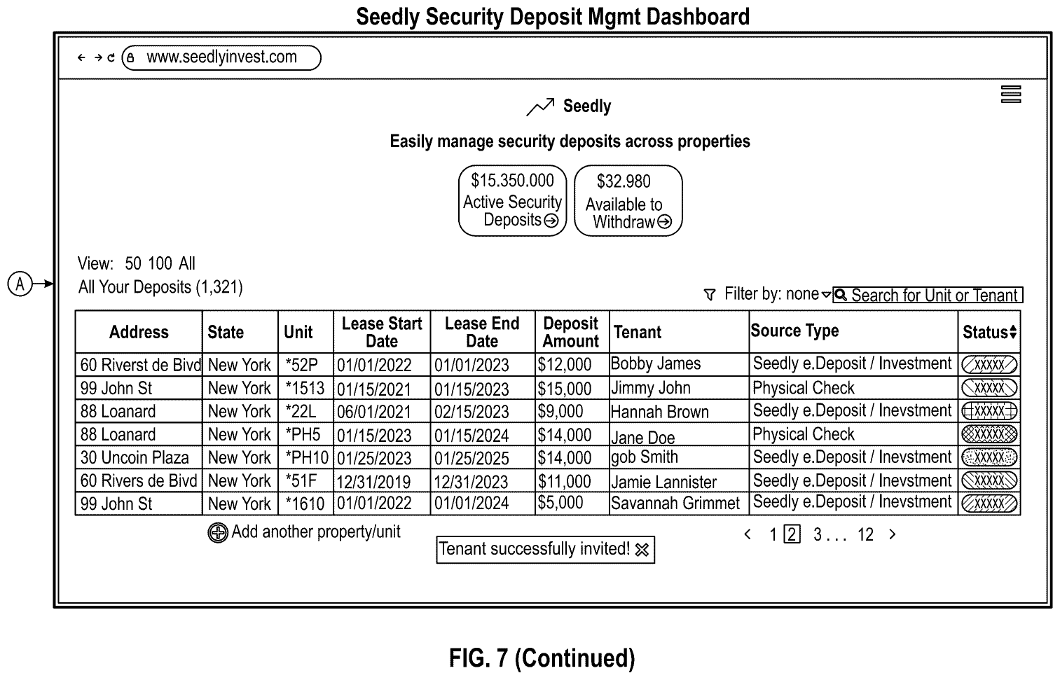

FIG. 7 shows a security deposit management workflow 700 according to an aspect of the present disclosure. The platform may include the security deposit management workflow 700. Security deposit management workflow 700 may include a security deposit management dashboard 702. Security deposit management dashboard 702 may allow a user to easily see, via a display of client device 102-106, all security deposits and related property information in connection with that user's account. Such information may include property address, state, lease start date, lease end date, deposit amount, tenant name, source type, status, or any other information useful to the user. The source type may include the method by which the security deposit was paid, for example, by check, or via the platform (described in further detail below). The status may correspond to the state of the security deposit. For several non-limiting examples, the status “pending” may indicate that the tenant has not yet added a security deposit; the status “active” may indicate that a deposit has been added and the escrow period is concurrently running; the status “close requested” may indicate that the tenant has requested return of the deposit; the status “closed” may indicate that the deposit has been returned to the tenant; and/or the status “disputed” may indicate that the tenant disagrees with the amount of deposit returned to them.

The security deposit management dashboard 702 may provide the user with an option, via a virtual button, to direct the user to add properties to the user's account via property and security deposit setup 704. Property and security deposit setup 704 may, via client device(s) 102-106, provide one or more fields in which to enter information necessary to add a property and security deposit to the user's account. Such information may include the property address, unit/apt number (if applicable), security deposit amount, lease duration (including start and end date), tenant's name, tenant's email address, or any other suitable information.

Once the user inputs the information requested by property and security deposit setup 704, the user may instruct the platform to save the information. Subsequently, the information may be stored and displayed via the security deposit management dashboard 702 as shown in the security deposit management dashboard 706. Security deposit management dashboard 706 may display, via client device(s) 102-106, to the user the amount in security deposits under their account, and the amount available to withdraw. The user may filter the data by the various categories of information contained therein. For example, the user may sort the data alphabetically by address, by lease end date (either newest or oldest), or by deposit amount (high to low, or low to high).

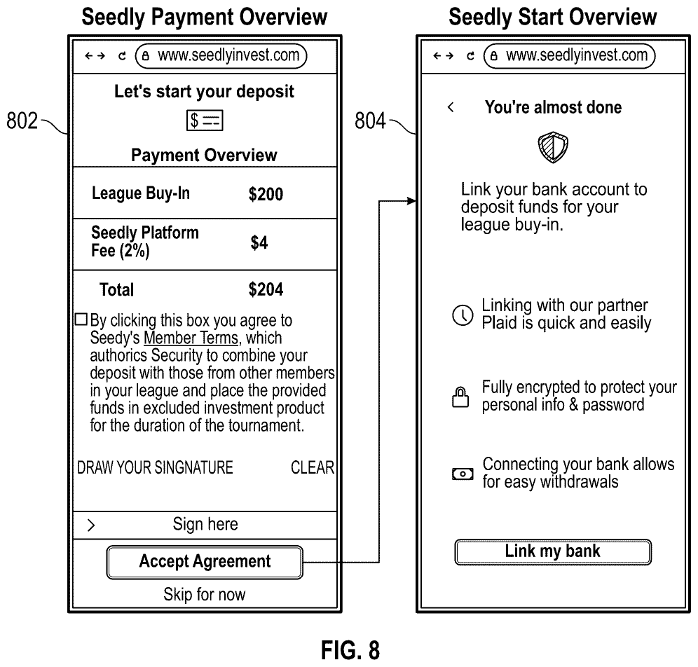

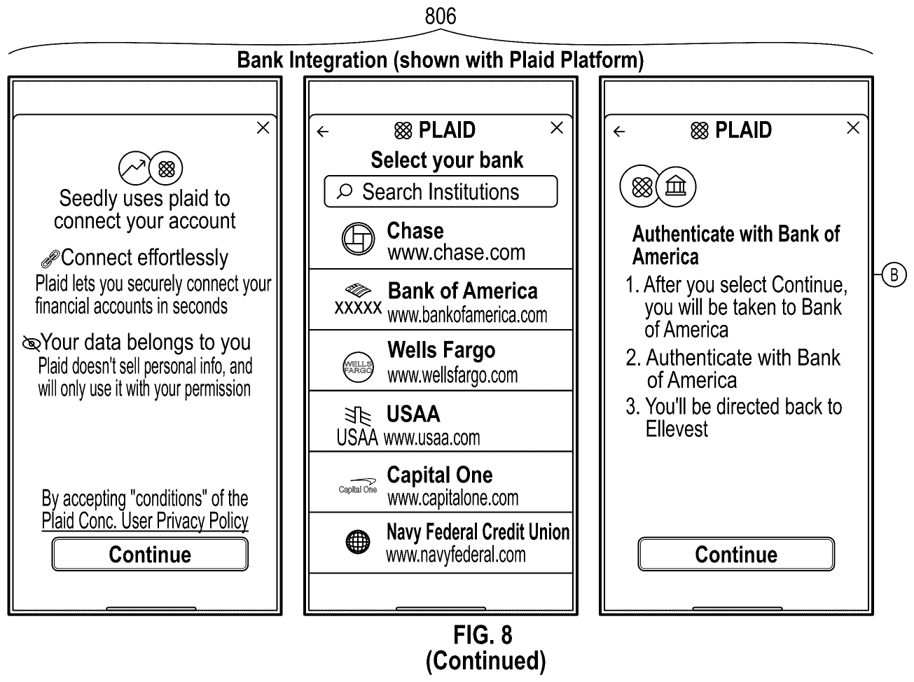

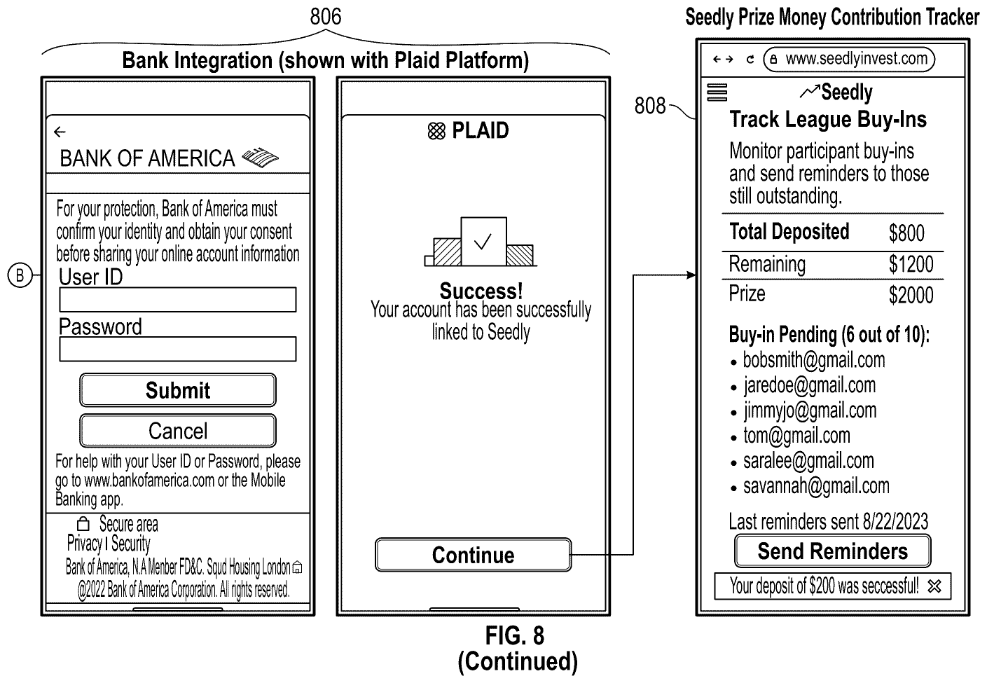

Turning to FIG. 8, during the fund compilation 304 phase, user may be directed to the fund compilation module 800. Fund compilation module 800 may be used in fantasy league/tournament use cases. In an embodiment, fund compilation module 800 includes payment overview 802. Payment overview 802 may display, via client device(s) 102-106, a summary of the payment configured for that user to make in participant view 604. If the information looks correct to the user, the user may accept the payment information and proceed to payment initiation 804. Payment initiation 804 may inform the user of the necessary steps to link their bank account to the platform.

To link the user's bank account, payment initiation 804 may direct the user to a third-party platform 806. Third-party platform 806 may provide serve as an intermediary, and a secure method for the user to link their bank account and process payments to the platform via client device(s) 102-106. In an embodiment, the user may connect their bank account directly to the platform without the need for third-party platform 806 via client device(s) 102-106.

Once the user has linked their bank account and made a payment to the platform, the payments may be tacked via the contribution tracker 808. Contribution tracker 808 may display to the user the total amount deposited from the various users, and the remaining deposit amount to be collected. Contribution tracker 808 may also display which users have, or have not, paid their deposit amount. The user may then be provided the option of sending a reminder to the participants who have yet to pay their deposit. Users may interact with contribution tracker 808 via I/O interface(s) 240 of client device(s) 102-106.

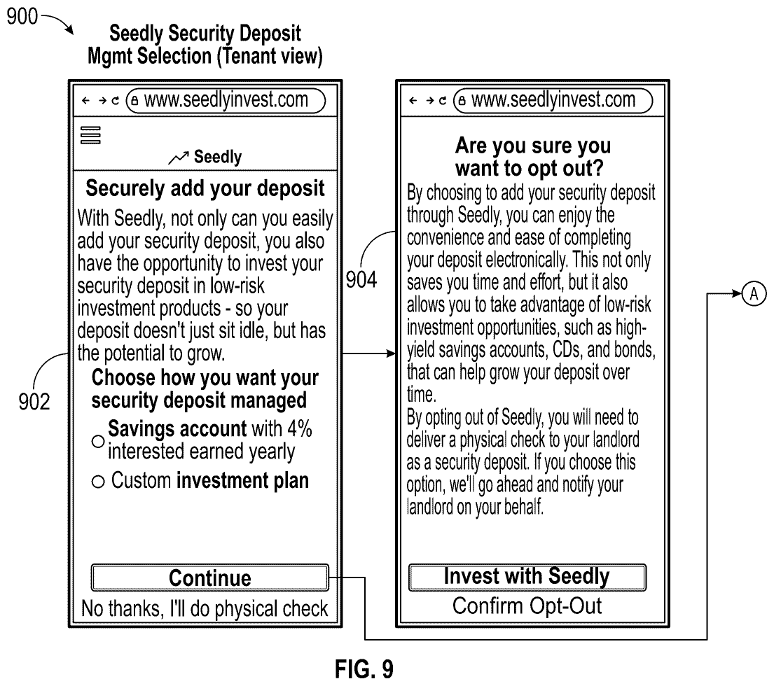

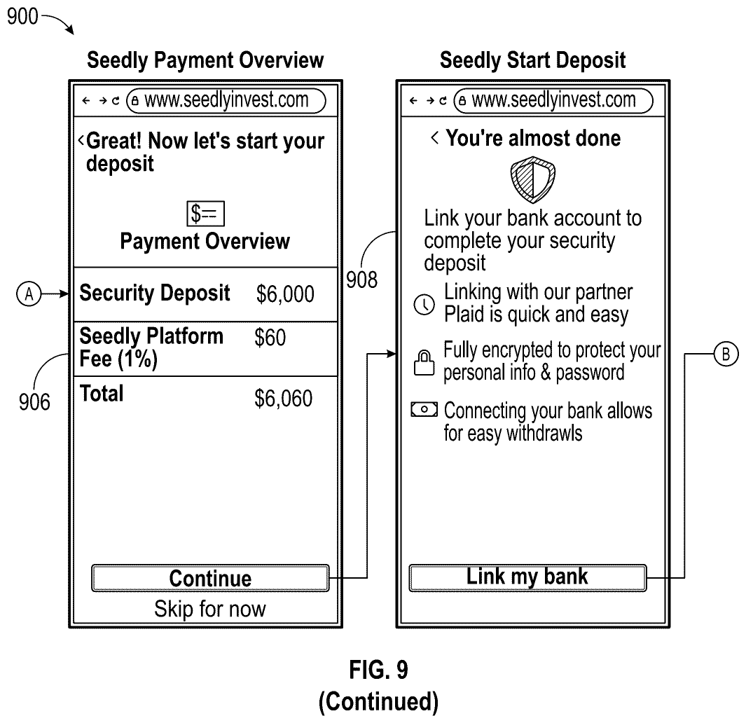

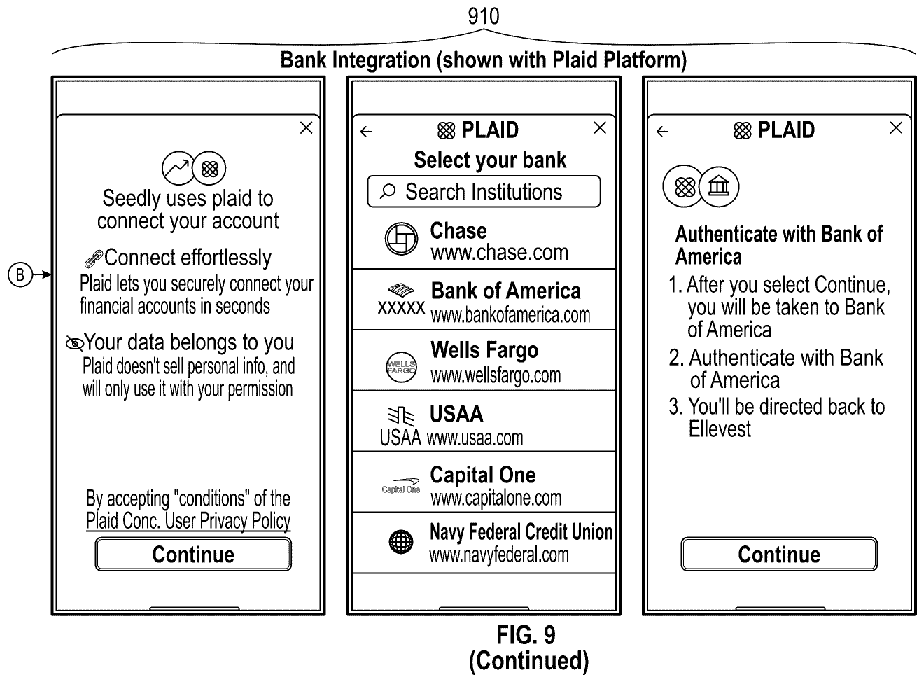

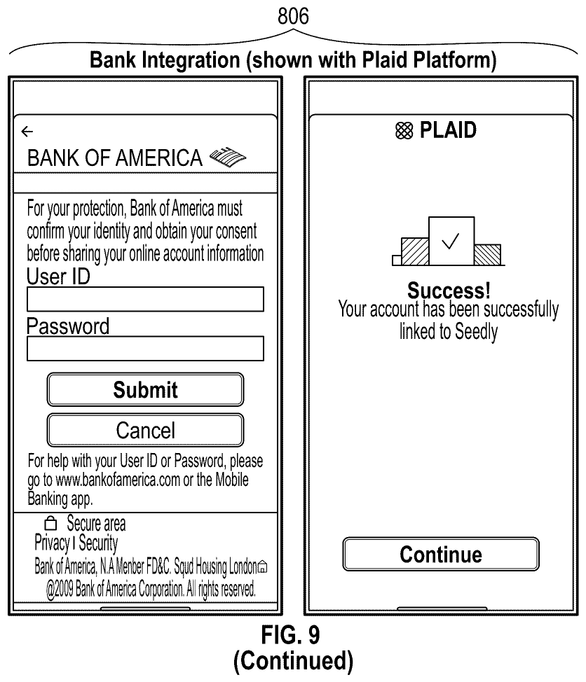

Turning to FIG. 9, during the fund compilation 304 phase, user may be directed to the fund compilation module 900. Fund compilation module 900 may be used in real estate security deposit use cases. In an embodiment, fund compilation module 900 includes security deposit management 902. Security deposit management 902 may provide the user with an option as to how the user would like their security deposit to be managed. For example, security deposit management 902 may include options to a) deposit the security deposit into a savings account with a predetermined interest rate, b) configure a custom investment plan to suit the user's specific needs, or c) to opt out of any investment options. If the user selects option “c),” the user may be directed to make the security deposit payment to their landlord outside of the platform, such as via a physical. This may be done via opt-out screen 904. Users may communicate their selected option(s) in response to security deposit management 902 via client device(s) 102-106.

If the user selects option “a)” or “b),” the user may be directed to payment overview 906 may display a summary of the payment configured for that user to make in account creation 500 or security deposit management workflow 700. If the information looks correct to the user, the user may accept the payment information and proceed to payment initiation 908. Payment initiation 908 may inform the user of the necessary steps to link their bank account to the platform.

To link the user's bank account, payment initiation 908 may direct the user to a third-party platform 910. Third-party platform 910 may provide a secure method for the user to link their bank account and process payments to the platform, via client device(s) 102-106. In an embodiment, the user may connect their bank account directly to the platform without the need for third-party platform 910.

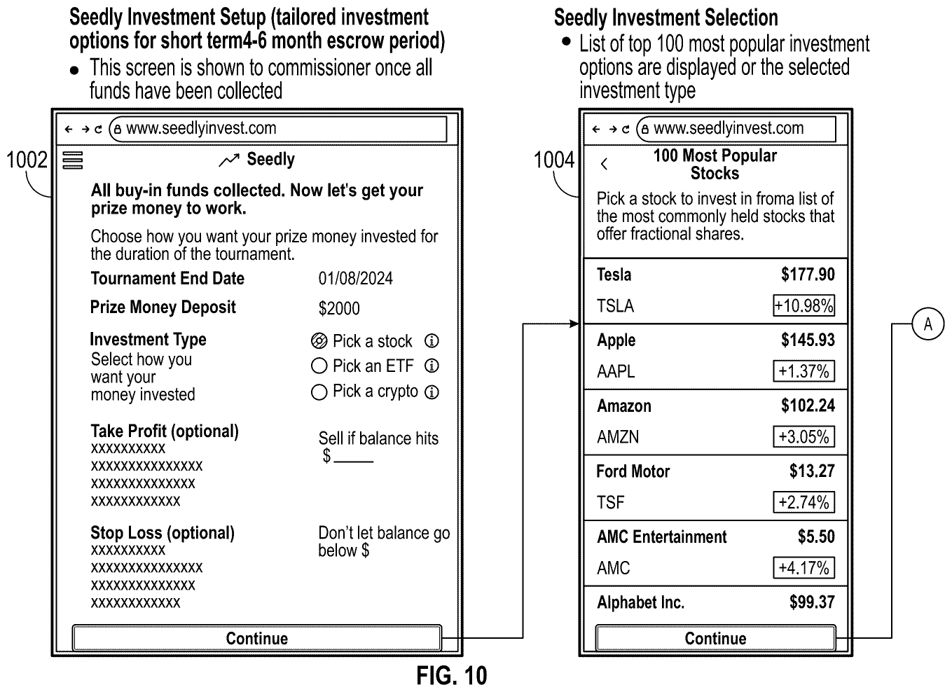

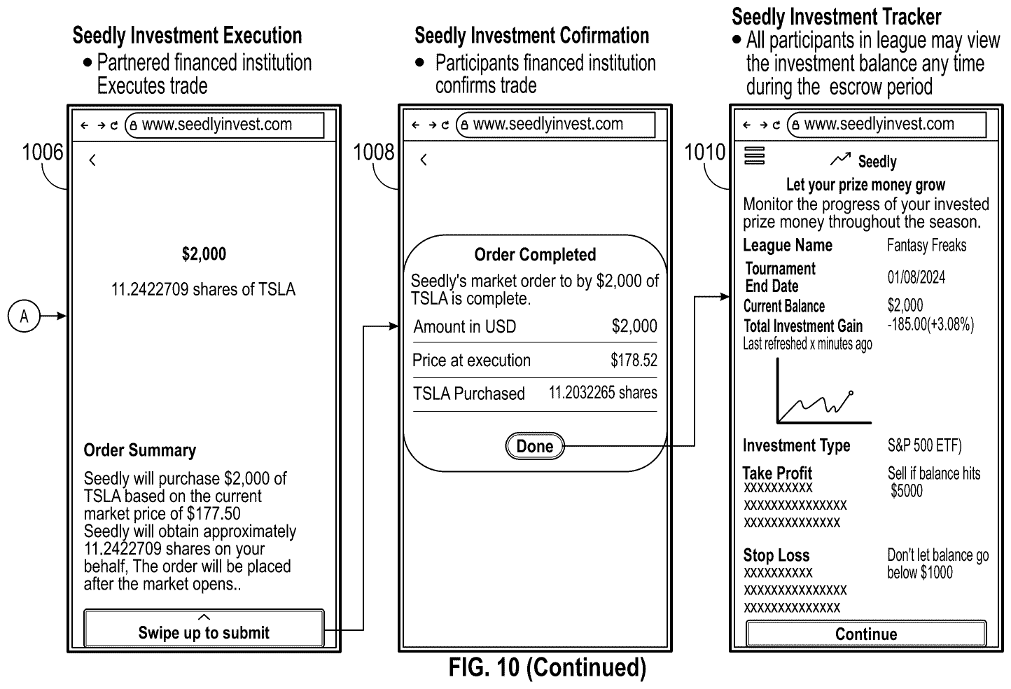

FIG. 10 illustrates an investment recommendation and investment tracker module 1000 according to an aspect of the present disclosure, which may be part of the investment selection phase 308. Investment recommendation and investment tracker module 1000 may be utilized by the platform in fantasy league/tournament use cases. The investment recommendation and investment tracker module 1000 may include investment setup module 1002. Investment setup module 1002 may be provided to the administrative user once all funds have been collected from the standard users/participants. Investment setup module 1002 may provide the user with various options for investing escrow funds 326. Investment setup module 1002 may be included in the investment selection phase 308. As part of investment setup module 1002, the user may be presented with one or more investment types. Investment types may include a stock selection, electronically managed fund (“ETF”) selection, crypto selection, or any other suitable investment type. The user may also configure a “take profit” value at which the platform should liquidate the invested funds if the value equals the value configured by the user. The user may also configure a “stop loss” value at which the invested funds should be liquidated to prevent the value of the funds dropping below the configured value. Users may communicate their response(s) to investment setup module 1002 via client device(s) 102-106.

Next, the user may be directed to the investment selection module 1004. Investment selection module 1004 may be included in the investment selection phase 308. Investment selection module 1004 may present to the user a variety of securities including but not limited to stocks, bonds, and/or certificates of deposit which the user may invest the escrow funds 326 in. Investment selection module 1004 may also present a variety of ETFs and/or crypto currencies to the user for selection for investing into. In an embodiment, the investment selection module 1004 may present the most popular 100 of each investment type to the user. Users may communicate their response(s) to investment selection module 1002 via client device(s) 102-106.

Once the user has configured the stock/ETF/crypto selection, the user may be directed to the investment execution module 1006. Investment execution module 1006 may be included in the investment execution phase 310. Investment execution module 1006 may instruct the user to confirm their investment selection. Upon doing so, the investment execution module 1006 may forward the order to a third-party financial institution. In an embodiment, the platform may be capable of executing the order. Users may confirm their selections via client device(s) 102-106.

Next, the user may be directed investment confirmation module 1008. Investment confirmation module 1008 may display to the user, a summary of the order and confirmation provided from the third-party financial institution. Investment confirmation module 1008 may present information to user(s) via one or more client devices 102-106.

The order information may then be communicated to an investment tracker module 1010. Investment tracker module 1010 may be included in the investment tracking phase 312. Investment tracker module 1010 may display a variety of investment data to the user via client devices 102-106. For example, the investment tracker module 1010 may display information including league/tournament information, current balance of the escrow funds 326, the investment type, “take profit” value, “stop loss” value, or any other relevant information.

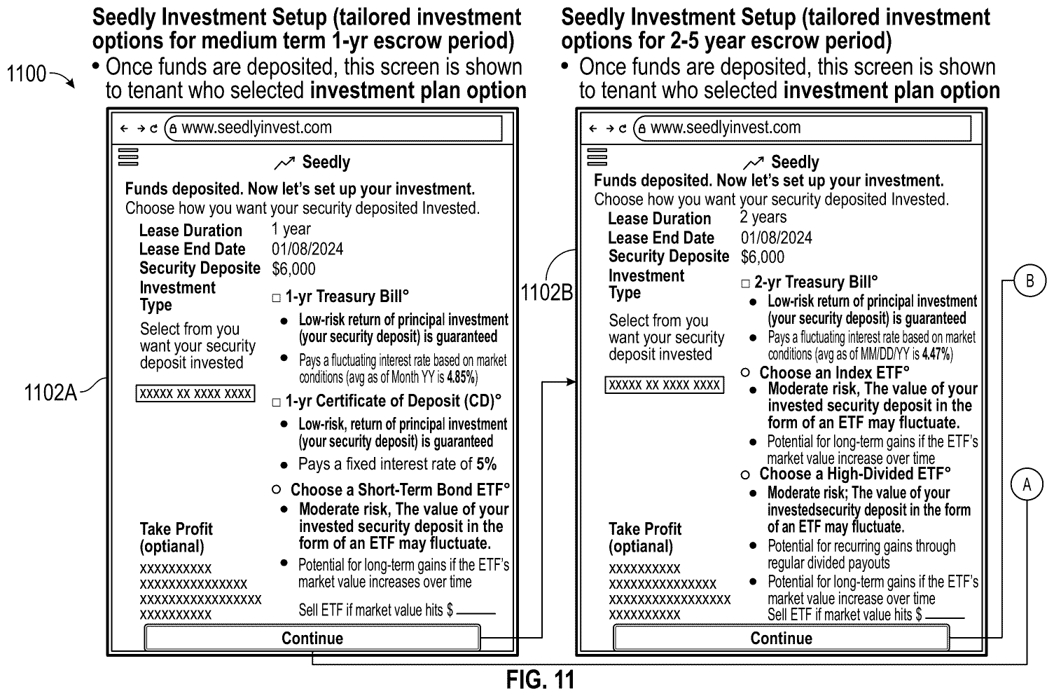

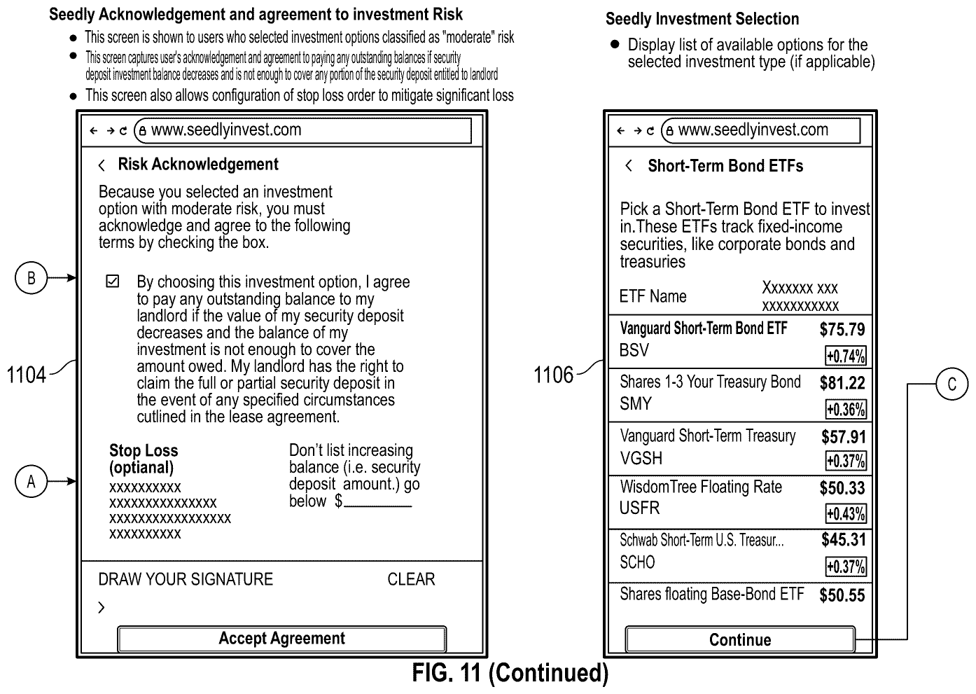

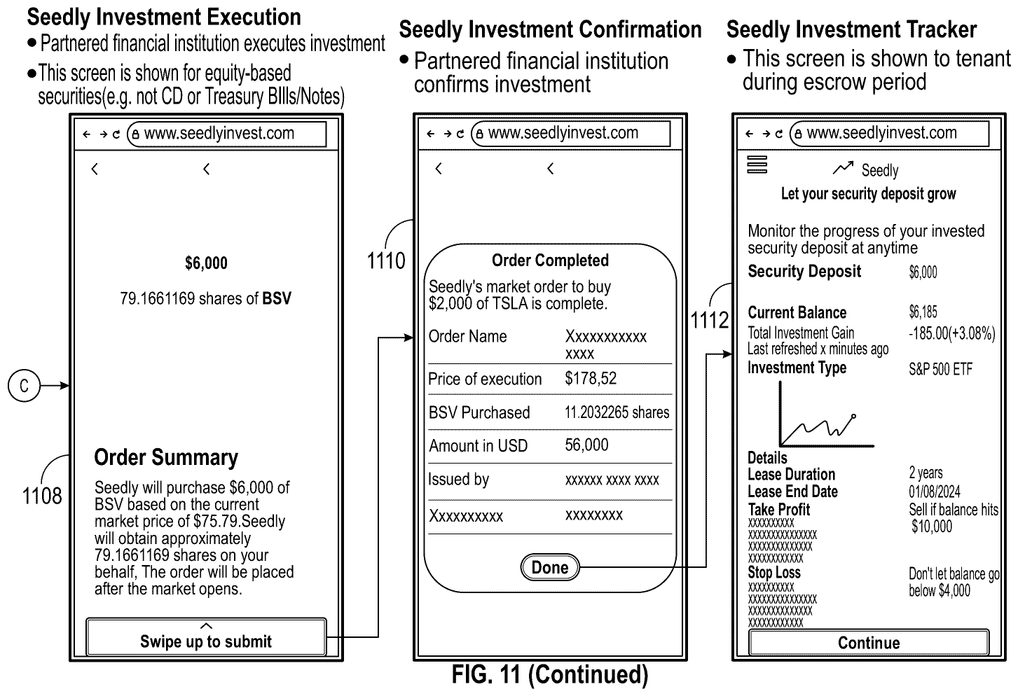

FIG. 11 illustrates an investment recommendation and investment tracker module 1100 according to another aspect of the present disclosure, which may be part of the investment selection phase 308. Investment recommendation and investment tracker module 1000 may be utilized by the platform in real estate security deposit use cases.

The investment recommendation and investment tracker module 1100 may include investment setup module 1102. Investment setup module 1102 may provide the user with various options for investing escrow funds 326. Investment setup module 1102 may be included in the investment selection phase 308. As part of investment setup module 1002, the user may be presented with one or more investment types via client device(s) 102-106. The user may be presented with different investment types depending on the duration of the escrow period. For example, a 1-yr escrow period may result in investment setup module 1102A. The investment types in investment setup module 1102A may include a 1-yr treasury bill, 1-yr certificate of deposit (“CD”), short-term bond ETF, or any other suitable investment type for that escrow period. As another example, a 2-yr escrow period may result in investment setup module 1102B. The investment types in investment setup module 1102B may include a 2-yr treasury note, an index ETF, a high dividend ETF, or any other suitable investment type for that escrow period. While 1-yr or 2-yr escrow periods are provided as examples, any suitable period of time may be used.

The user may also configure a “take profit” value at which the platform should liquidate the invested funds if the value equals the value configured by the user. The user may also configure a “stop loss” value at which the invested funds should be liquidated to prevent the value of the funds dropping below the configured value.

Next, the user may be directed to an acknowledgement and risk agreement module 1104. The user may be directed to acknowledgement and risk agreement module 1104 based on the risk of the chosen investment types. For example, a user may be directed to acknowledgement and risk agreement module 1104 if they chose an investment type with at least a moderate risk classification. Users who have not chosen any investment type with at least a moderate risk level may bypass the acknowledgement and risk agreement module 1104.

Acknowledgement and risk agreement module 1104 may provide the user with certain agreements and/or acknowledgements the user must sign to progress to the next module. In an embodiment, the user is prompted to configure the “stop loss” value if they have not already done so. Acknowledgement and risk agreement module 1104 may be presented to user(s) via client device(s) 102-106.

Next, the user may be directed to the investment selection module 1106. Investment selection module 1106 may be included in the asset allocation phase 314. Investment selection module 1106 may present, via client device(s) 102-106 to the user a variety of investment types in which the user may invest the escrow funds 326. Investment selection module 1104 may display all available options to the user for the investment type(s) selected in the investment setup module 1102.

Once the user has configured the investment type selection, the user may be directed to the investment execution module 1108. Investment execution module 1108 may be included in the investment execution phase 310. Investment execution module 1108 may instruct the user to confirm their investment selection via client device(s) 102-106. Upon doing so, the investment execution module 1108 may forward the order to a third-party financial institution via one or more server(s) 107-109 and 113. In an embodiment, the platform may be capable of executing the order.

The investment execution module 1108 may only be displayed based on the investment types chosen by the user. For example, the user may bypass the investment execution module 1108 unless they selected if the user selected an equity-based investment type.

Next, the user may be directed investment confirmation module 1110. Investment confirmation module 1110 may display to the user, via client device(s) 102-106, a summary of the order and confirmation provided from the third-party financial institution.

The order information may then be communicated to an investment tracker module 1112. Investment tracker module 1112 may be included in the investment tracking phase 312. Investment tracker module 1112 may, via client device(s) 102-106, display a variety of investment data to the user. For example, the investment tracker module 1112 may display information including security deposit amount, current balance of the escrow funds 326, the investment type, lease duration, lease end date, “take profit” value, “stop loss” value, or any other relevant information.

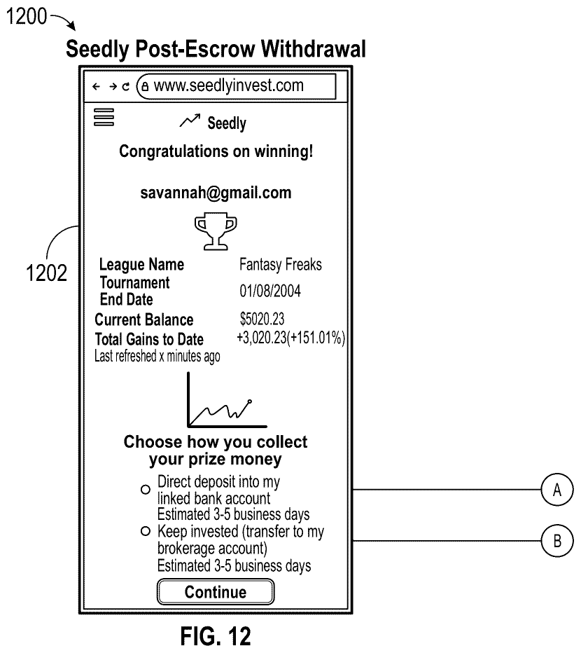

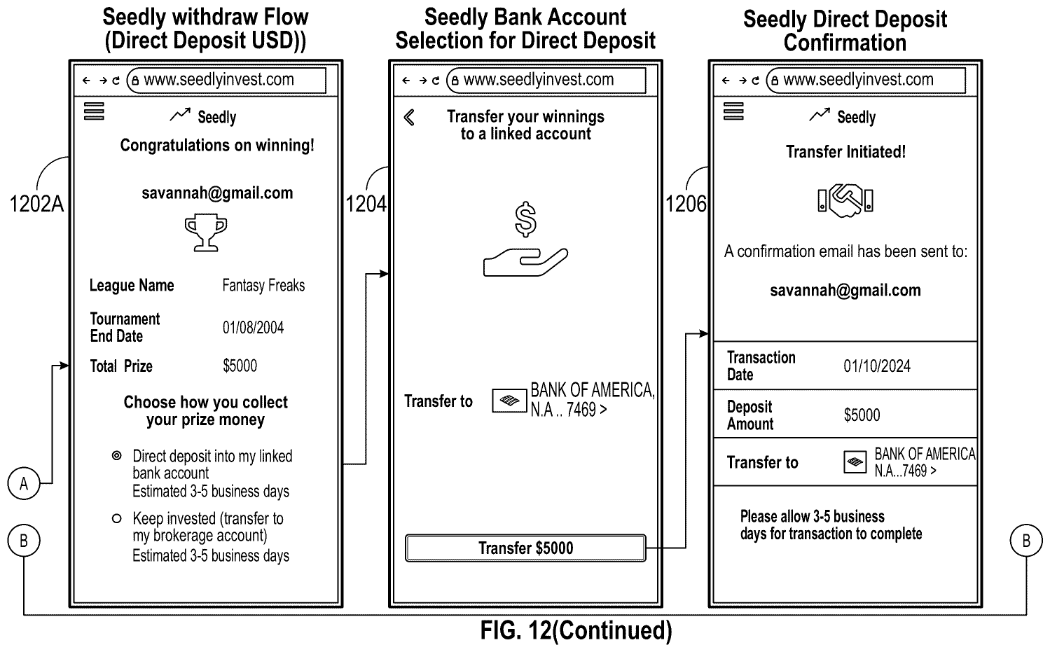

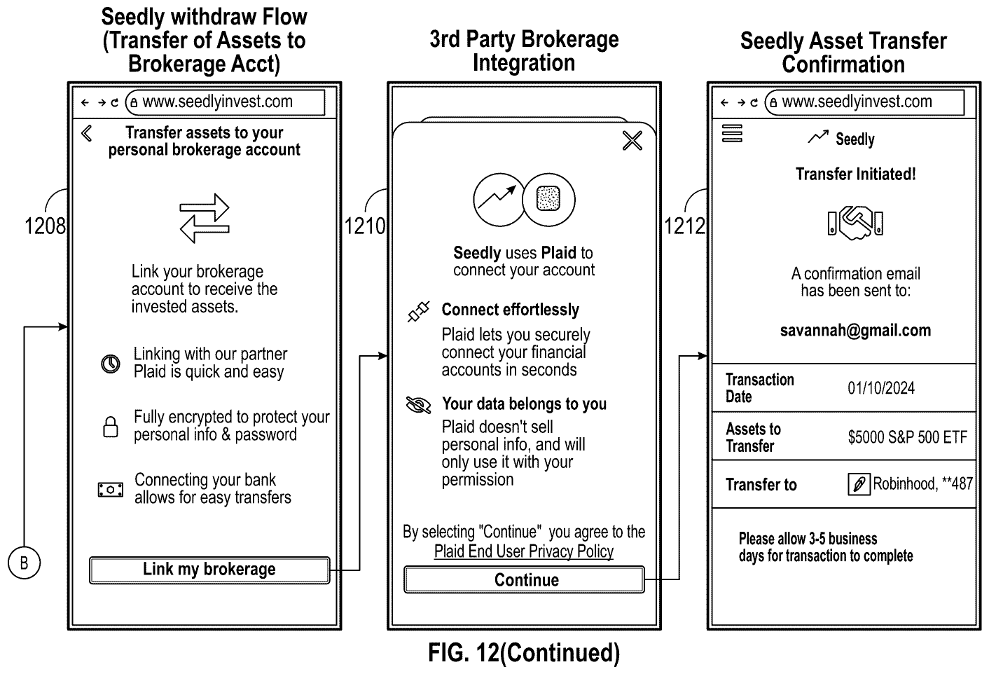

FIG. 12 illustrates a post-escrow fund/asset distribution module 1200 according to an aspect of the present disclosure, which may be used in fantasy league/tournament use cases. Asset distribution module 1200 may be included in the post-escrow period 380. Asset distribution module 1200 may include a post-escrow withdrawal module 1202. Users may be directed toward post-escrow withdrawal module 1202 if they won prize money from the league/tournament. The prize money may be a total amount of the escrow funds 326, or a portion thereof. Post-escrow withdrawal module 1202 may display, via client device(s) 102-106, a variety of information to the user related to the prize money. For example, post-escrow withdrawal module 1202 may display information including league/tournament name, league/tournament end date, current balance of escrow funds 326, gains from the chosen investment types, apportionment of the escrow funds 326 according to rankings in the league/tournament, or any other relevant information.

In an embodiment, the post-escrow withdrawal module 1202 may provide the user with one or more options for withdrawing their prize money. For example, the user may be provided with an option to either a) a direct deposit election 1202A to deposit the funds into a linked bank account belonging to the user, or b) transfer the invested funds into a brokerage account belonging to the user. Users may make responsive selections to post-escrow withdrawal module 1202 via one or more client device(s) 102-106.

If the user selects the direct deposit election 1202A, the user may be directed to the direct deposit module 1204. Direct deposit module 1204 may present the user with a field to select their desired bank account into which the user would like the prize money to be deposited. Such field may include a drop-down menu. The drop-down menu may include bank accounts which have previously been linked to the platform as described supra.

After selecting and confirming the desired bank account, the user may be directed to a direct deposit confirmation module 1206. The direct deposit confirmation module 1206 may include information related to the direct deposit transfer, such as email to which a confirmation email may be sent, transaction date, deposit amount, bank account information, anticipated transaction completion timeframe, and/or any other relevant information.

If a user selects option “b)” in the post-escrow withdrawal module 1202, and has already linked a brokerage account, then the user may be directed through modules 1204/1206, except the deposit amount will be a brokerage balance, and the bank account information will be brokerage account information.

If the user does not have a linked brokerage account, the user may be directed to the brokerage link module 1208. Brokerage link module 1208 may inform the user of the necessary steps to link their bank account to the platform.

To link the user's brokerage account, brokerage link module 1208 may direct the user to a third-party platform 1210. Third-party platform 1210 may provide a secure method for the user to link their brokerage account and enable transfers to the user's brokerage account. In an embodiment, the user may connect their brokerage account directly to the platform without the need for third-party platform 1210.

After linking their brokerage account, the user may be directed to an asset transfer confirmation module 1212. The asset transfer confirmation module 1212 may include information related to the direct deposit transfer, such as email to which a confirmation email may be sent, transaction date, asset information, brokerage account information, anticipated transaction completion timeframe, and/or any other relevant information.

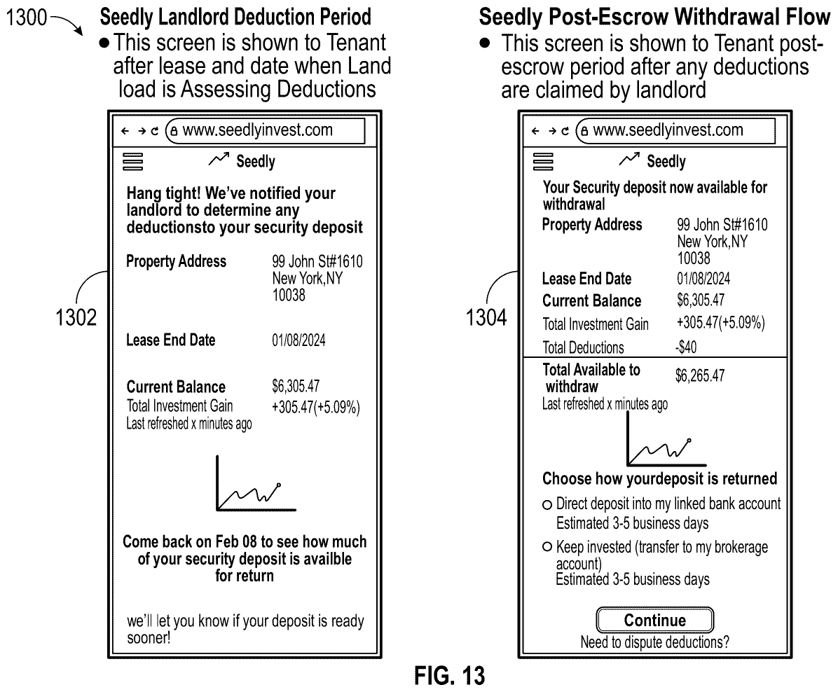

FIG. 13 illustrates a post-escrow fund/asset distribution module 1300, which may relate to real estate security deposit use cases according to another aspect of the present disclosure. The asset distribution module 1300 may include a deduction period module 1302. Deduction period module 1302 may be accessible by a standard user/tenant after the lease end date but before the administrative user/landlord has taken any deduction of fees or other relevant expenses from the escrow funds 326. When a standard user/tenant wishes to withdraw the escrow funds 326, the deduction period module 1302 may prevent the user from doing so. Deduction period module 1302 may include information relevant to the user's situation, such as property address, lease end date, current balance of escrow funds 326, when the escrow funds 326 will be available for withdrawal, or any other relevant information. The date on which the escrow funds 326 will be available for withdrawal may change depending on when the administrative user/landlord makes any deductions, or when the period in which administrative user/landlord may make deductions expires. For example, as shown in FIG. 13, if the period during which the administrative user/landlord may make deductions is 1-month, the date on which the escrow funds 326 will be available for withdrawal may be 1-month after the lease end date. Based on this example, if the administrative user/landlord makes deductions 10-days after the lease end date, then the date on which the escrow funds 326 will be available for withdrawal may be 10-days after the lease end date.

Once the escrow funds 326 will be available for withdrawal, the user may be allowed access to the post-escrow withdrawal module 1304. Post-escrow withdrawal module 1304 may, via client device(s) 102-106, display information to the user such as property address, lease end date, current balance of escrow funds 326, or any other relevant information.

The post-escrow withdrawal module 1304 may, via client device(s) 102-106, provide the user with one or more options for withdrawing their prize money. For example, the user may be provided with an option to either a) a direct deposit election to deposit the funds into a linked bank account belonging to the user, or b) transfer the invested funds into a brokerage account belonging to the user. Depending on the user's selection, the user will then be directed through modules 1204/1206/1208/1210/1212 in accordance with the above descriptions.

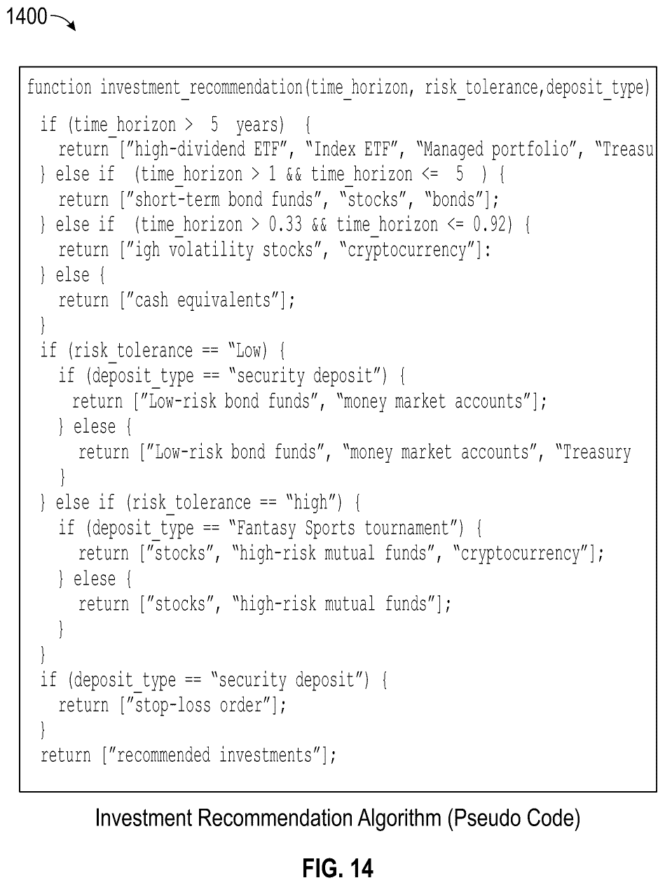

FIG. 14 illustrates pseudo-code for an investment recommendation algorithm 1400 according to aspects of the present disclosure. Specifically, algorithm 1400 may be utilized in modules 1002/1102/1104. Algorithm 1400 may be a function of escrow period, risk tolerance, and deposit type. In an embodiment, algorithm 1400 may limit which investment types are made available to the user based on the escrow period. For example, if the escrow period is more than 1 year, and less than or equal to 5 years, the available investment types may be limited to include short term bond funds, stocks, and bonds.

The algorithm 1400 may also limit the investment types based on risk tolerance. As a non-limiting example, the algorithm 1400 may utilize the risk tolerance as indicated in organization creation 302 to suggest appropriate investment options to the user. As a non-limiting example, the algorithm 1400 may present one or more initial set(s) of investment types categorized by approximate level of risk. For example, if the user indicates they have a high risk tolerance by selecting a high-risk set of investment types or indicating their preference as high risk, the available investment types may include stocks, high-risk mutual funds, and cryptocurrency.

The algorithm 1400 may cause the platform to provide a “stop loss” option as described above. In an embodiment, the algorithm 1400 may provide a “stop loss” option if the deposit is a security deposit.

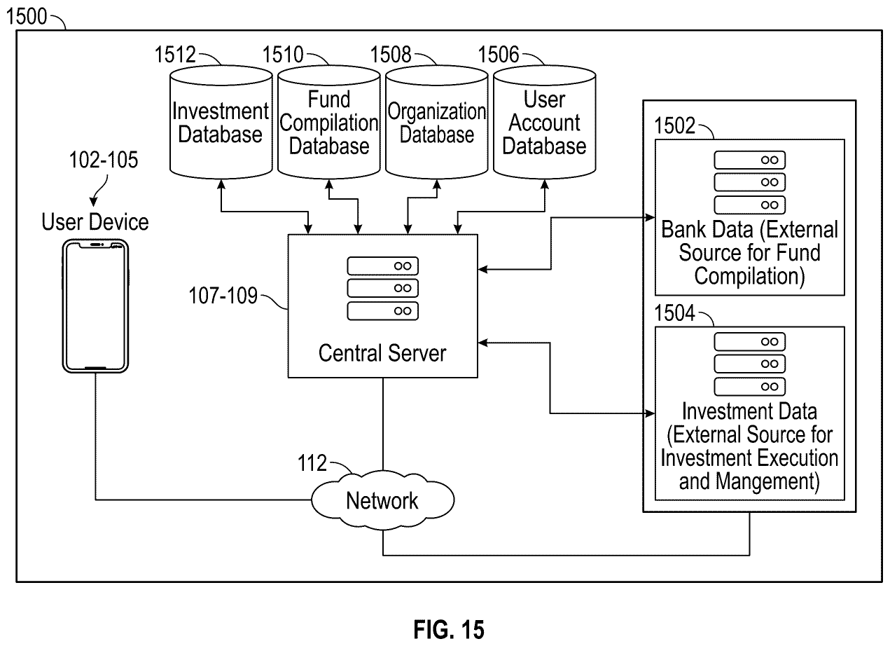

FIG. 15 shows a high-level system architecture 1500 according to aspects of the present disclosure. The high-level system architecture 1500 may dictate how the various information discussed herein is stored and obtained. For example, external servers 1502 may store bank data for use during fund compilation 304. Investment data may be stored on external servers 1504. Such investment data may be the data obtained during investment selection phase 308, investment execution phase 310, and investment tracking phase 312.

Information specific to the platform may be stored on databases 1506/1508/1510/1512. Database 1506 may store user information, which may comprise indications of user type, verified email addresses, names of user, verified phone numbers, account status, and any identifying information associated with external accounts, including deposit information. Such information may be received from the user via the organization creation module 302.

Database 1508 may store information relating to each established organization, which may include the property UUID, escrow end date, number of participants, required deposit amount, fund compilation UUID, investment account link UUID, and/or organization names as indicated by user(s) in organization creation 302.

Database 1510 may store information relating to fund compilation 304, including but not limited to the required deposit amount per user in each organization, the user account UUID(s) associated with each completed transaction, and/or the user account UUID(s) associated with incomplete transactions.

Database 1512 may store information related to the investment accounts associated with each organization, including investment account link UUID's, dates correlating to the investment execution date, investment closure date, order of user eligibility for withdrawal upon the close of escrow period for each organization, an indication of the withdrawal type for each organization (e.g. security deposit return, tournament winnings, etc.), and a list of withdrawal(s) made for each organization with the date, amount of withdrawal, initial deposit amount, latest balance, and investment status after each withdrawal. Databases 1506/1508/1510/1512 may be stored on servers 107-109, or may exist as separate servers.

It will be apparent to those of ordinary skill in the art that methods involved in the present disclosure may be embodied in a computer program product that includes a computer usable and/or readable medium. For example, such a computer usable medium may consist of a read only memory device, such as a CD ROM disk or conventional ROM devices, or a random-access memory, such as a hard drive device or a computer diskette, or flash memory device having a computer readable program code stored thereon.

Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A computer-implemented system comprising a processor, a computer-readable memory, a computer-readable storage device, at least one network interface, at least one input interface, at least one output interface, and program instructions stored on the computer-readable storage device for execution by at the processor via the computer-readable memory, the stored program instructions comprising:
receiving, from a user via a client device, instructions to execute an organization creation module,
wherein, the organization creation module receives data via an input from the user via the client device, and generates a record of the input on at least one database;
receiving, from the user via the client device, instructions to execute a fund compilation module;
wherein the fund compilation module comprises at least a fund collection step and a fund sufficiency check,
wherein the fund collection step includes receiving a transfer of funds from one or more users into a deposit account, and recording the transfer on one or more databases, and
wherein the funds sufficiency check includes comparing the funds transferred to a predefined minimum threshold;
receiving, from the user via the client device, instructions to execute an investment selection module configured to assess user input via the client device and provide a customized selection of investment vehicles for the funds;
wherein the investment selection module includes at least risk tolerance information input by the user via the client device;
receiving, from the user via the client device, instructions to execute an investment execution module for redirecting the funds into one or more investment vehicles for a duration of a predefined period;
receiving, from the user via the client device, instructions to execute an investment tracker module,
wherein the investment tracker module is configured to monitor a balance of the deposit account, and
wherein the investment tracker module displays to the user, via a display, the balance of deposit account during the duration of the predefined period; and
receiving, from the user via the client device, instructions to execute an asset distribution module,
wherein the asset distribution module is configured to transfer the deposit account funds to one or more external accounts in accordance with one or more predetermined parameters.

2. The computer-implemented system of claim 1, wherein the system collects and compiles funds from all users utilizing a third-party provider to provide an intermediary link between user's bank accounts and the system.

3. The computer-implemented system of claim 1, wherein the funds are for security deposits for rental properties, and the system collects and compiles funds from all users utilizing a third-party provider to provide an intermediary link between user's bank accounts and the system, and wherein the asset distribution module distributes the funds to the one or more users less one or more fees due to a landlord.

4. A method for investment vehicle distribution of escrow funds, the method comprising the steps of:
receiving, from a user via a client device, instructions to execute an organization creation module,
wherein, the organization creation module receives data via an input from the user via the client device, and generates a record of the input on at least one database;
receiving, from the user via the client device, instructions to execute a fund compilation module;
wherein the fund compilation module comprises at least a fund collection step and a fund sufficiency check,
wherein the fund collection step includes receiving a transfer of funds from one or more users into a deposit account, and recording the transfer on one or more databases, and
wherein the funds sufficiency check includes comparing the funds transferred to a predefined minimum threshold;
receiving, from the user via the client device, instructions to execute an investment selection module configured to assess user input via the client device and provide a customized selection of investment vehicles for the funds;
wherein the investment selection module includes at least risk tolerance information input by the user via the client device;
receiving, from the user via the client device, instructions to execute an investment execution module for redirecting the funds into one or more investment vehicles for a duration of a predefined period;
receiving, from the user via the client device, instructions to execute an investment tracker module,
wherein the investment tracker module is configured to monitor a balance of the deposit account, and
wherein the investment tracker module displays to the user, via a display, the balance of deposit account during the duration of the predefined period; and
receiving, from the user via the client device, instructions to execute an asset distribution module,
wherein the asset distribution module is configured to transfer the deposit account funds to one or more external accounts in accordance with one or more predetermined parameters.

5. The method of claim 4, wherein the funds are collected and compiled from all users utilizing a third-party provider to provide an intermediary link between user's bank accounts and the deposit account.

6. The method of claim 4, wherein the funds are for security deposits for rental properties, and the funds are collected and compiled from all users utilizing a third-party provider to provide an intermediary link between user's bank accounts and the deposit account, and wherein the asset distribution module distributes the funds to the one or more users less one or more fees due to a landlord.

7. A computer-readable storage medium having data stored therein representing software executable by a computer, the software having instructions to:
receive, from a user via a client device, instructions to execute an organization creation module,
wherein, the organization creation module receives data via an input from the user via the client device, and generates a record of the input on at least one database;
receive, from the user via the client device, instructions to execute a fund compilation module;
wherein the fund compilation module comprises at least a fund collection step and a fund sufficiency check,
wherein the fund collection step includes receiving a transfer of funds from one or more users into a deposit account, and recording the transfer on one or more databases, and
wherein the funds sufficiency check includes comparing the funds transferred to a predefined minimum threshold;
receive, from the user via the client device, instructions to execute an investment selection module configured to assess user input via the client device and provide a customized selection of investment vehicles for the funds;
wherein the investment selection module includes at least risk tolerance information input by the user via the client device;
receive, from the user via the client device, instructions to execute an investment execution module for redirecting the funds into one or more investment vehicles for a duration of a predefined period;
receive, from the user via the client device, instructions to execute an investment tracker module,
wherein the investment tracker module is configured to monitor a balance of the deposit account, and
wherein the investment tracker module displays to the user, via a display, the balance of deposit account during the duration of the predefined period; and
receive, from the user via the client device, instructions to execute an asset distribution module,
wherein the asset distribution module is configured to transfer the deposit account funds to one or more external accounts in accordance with one or more predetermined parameters.
